(19) United States
(12) Patent Application Publication
(10) Pub. No.: US 2017/0108752 A1
(43) Pub. Date: Apr. 20, 2017

(54) ELECTROCHROMIC-THERMOCHROMIC DEVICES AND METHODS OF MAKING AND USE THEREOF

(71) Applicant: Board of Regents, The University of Texas System, Austin, TX (US)

(72) Inventors: Delia Milliron, Austin, TX (US); Gabriel LeBlanc, Austin, TX (US); Amy Bergerud, Austin, TX (US)

(21) Appl. No.: 15/293,807

(22) Filed: Oct. 14, 2016

Related U.S. Application Data
(60) Provisional application No. 62/242,044, filed on Oct. 15, 2015.

(51) Int. Cl. G02F 1/155; G02F 1/01

(52) U.S. Cl. CPC G02F 1/155; G02F 1/0147; G02F 2001/1555

(57) ABSTRACT

Disclosed herein are electrochromic devices. The electrochromic devices can comprise: an electrochromic-thermochromic electrode comprising a first conducting layer and an electrochromic-thermochromic layer, wherein the first conducting layer is in electrical contact with the electrochromic-thermochromic layer, and wherein the electrochromic-thermochromic layer comprises a material exhibiting electrochromic and thermochromic behavior; a counter electrode comprising a counter layer and a second conducting layer, wherein the second conducting layer is in electrical contact with the counter layer; and a non-intercalating electrolyte; wherein the first conducting layer is in electrical contact with the second conducting layer; and wherein the electrochromic-thermochromic layer and the counter layer are in electrochemical contact with the non-intercalating electrolyte.

### CROSS-REFERENCE TO RELATED APPLICATIONS

This application claims the benefit of U.S. Provisional Application No. 62/242,044, filed Oct. 15, 2015, which is hereby incorporated herein by reference in its entirety.

### STATEMENT OF GOVERNMENT SUPPORT

This invention was made with government support under Grant no. DE-AC02-05CH11231 awarded by the Department of Energy. The government has certain rights in the invention.

### BACKGROUND

A large portion of the world's energy expenditure is devoted to the heating, cooling and lighting of buildings. Energy efficient windows have been developed using either thermochromic or electrochromic films. These films reversibly alter their optical properties in response to heat or electrical stimulus. Although some materials exhibit a gradual optical transition over a temperature or voltage range, others exhibit a sharp transition at a defined temperature or voltage switch. Sharp transitions are generally achieved through a phase change mechanism, wherein a material in a film undergoes a melting or polymorphic transition. The phase change is accompanied by a change in ligand field strength or co-ordination geometry, resulting in a change of optical properties.

Films that reduce their transparency in response to added heat have been explored for the production of so-called “smart windows.” These windows save on cooling costs by reducing transmission of solar insolation at higher temperatures. However, the optical properties of the windows cannot be tuned independently of the thermal environment they are in.

Electrochromic films can also be used to reduce near infrared transmission, but they must be actively switched by applying a current. Some electrochromic materials are colored by reduction, such as WO₃, MoO₃, V₂O₅, Nb₂O₅ or TiO₂, and other electrochromic materials are colored by oxidation, such as Cr₂O₃, MnO₂, CoO or NiO.

It is an object of the invention to provide a film exhibiting both electrochromic and thermochromic properties. It is a further object of the invention to provide a film having controllable transparency to near infrared light. It is another object of the invention to provide a device in which the near infrared transparency can be either manually or automatically controlled.

### SUMMARY

In accordance with the purposes of the disclosed devices and methods, as embodied and broadly described herein, the disclosed subject matter relates to electrochromic devices and methods of making and using the devices.

Additional advantages of the disclosed devices and methods will be set forth in part in the description which follows, and in part will be obvious from the description. The advantages of the disclosed devices will be realized and attained by means of the elements and combinations particularly pointed out in the appended claims. It is to be understood that both the foregoing general description and the following detailed description are exemplary and explanatory only and are not restrictive of the disclosed devices and methods, as claimed,

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The accompanying figures, which are incorporated in and constitute a part of this specification, illustrate several aspects of the disclosure, and together with the description, serve to explain the principles of the disclosure.

FIG. 1 is a schematic diagram of an electrochromic device.

FIG. 2 is an optical photograph of nanocrystalline vanadium dioxide films on ITO glass before thermal annealing (panel A) and after thermal annealing (panel B).

FIG. 3 is a transmission electron microscopy image of as synthesized V₂O₃ with the corresponding electron diffraction pattern in the inset, which can be indexed to the bixbyite phase of V₂O₃.

FIG. 4 is a TEM images VO₂ nanocrystals generated via thermal annealing.

FIG. 5 is a scanning electron microscopy image of a nanocrystalline V₂O₃ fill (inset) and a nanostructured VO₂ film, realized after thermal annealing of a V₂O₃ film.

FIG. 6 shows the in-situ X-ray diffraction (XRD) pattern of V₂O₃ nanocrystals annealed in air (panel a and panel c) and in 250 ppm O₂ in N₂ (panel b and panel d),

FIG. 7 shows the X-ray diffraction pattern of bixbyite V₂O₃ nanocrystals (top) and monoclinic VO₂ nanocrystals (bottom) realized after thermal annealing of a V₂O₃ film. Reference X-ray diffraction patterns [ICSD collection code 260212 and 15889] are shown in each plot.

FIG. 8 shows the scanning electron microscopy (SEM) image (left panel), wide angle X-ray scattering (WAXS) pattern of the monoclinic (011) peak used for Scherrer crystallite size analysis (middle panel), and extinction at 2000 nm measured against time during charging at −1.5 V in 0.1 M TBA-TFSI in PC in argon atmosphere at 25° C. (right panel) for nanocrystal domain 23 nm in size, from annealing at 362° C. Film was 118±12 nm thick.

FIG. 9 shows the scanning electron microscopy (SEM) image (left panel), wide angle X-ray scattering (WAXS) pattern of the monoclinic (011) peak used for Scherrer crystallite size analysis middle panel), and extinction at 2000 nm measured against time during charging at −1.5 V in 0.1 M TBA-TFSI in PC in argon atmosphere at 25° C. (right panel) for nanocrystal domain 25 nm in size, from annealing at 362° C. Film was 118±12 nm thick.

FIG. 10 shows the scanning electron Microscopy (SEM) image (left panel), wide angle X-ray scattering (WAXS) pattern of the monoclinic (011) peak used for Scherrer crystallite size analysis (middle panel), and extinction at 2000 nm measured against time during charging at −1.5 V in 0.1 M TBA-TFSI in PC in argon atmosphere at 25° C. (right panel) for nanocrystal domain 35 nm in size, from annealing at 375° C. Film was 118±12 nm thick.

FIG. 11 shows the scanning electron microscopy (SEM) image (left panel), wide angle X-ray scattering (WAXS) pattern of the monoclinic (011) peak used for Scherrer crystallite size analysis (middle panel), and extinction at 2000 nm measured against time during Charging at −1.5 V in 0.1 M TBA-TFSI in PC in argon atmosphere at 25° C. (right panel) for nanocrystal domain 38 nm in size, from annealing at 400° C. Film was 118±12 nm thick.

FIG. 12 shows the scanning electron microscopy (SEM) image (left panel), wide angle X-ray scattering (WAXS) pattern of the monoclinic (011) peak used for Scherrer crystallite size analysis (middle panel), and extinction at 2000 nm measured against time during charging at −1.5 V in 0.1 M TBA-TFSI in PC in argon atmosphere at 2.5° C. (right panel) for nanocrystal domain 50 nm in size, from annealing at 400° C. Film was 118±12 nm thick.

FIG. 13 shows the transmittance spectra of nanocrystal thin films demonstrating minimal change for V₂O₃ and dramatic near infrared (NIR) modulation for VO₂ as a function of temperature.

FIG. 14 is an optical image with labels for the variable temperature spectroelectrochemistry setup used in the manuscript. The entire system was house in an argon glovebox to minimize any effects from oxygen and water. Experiments were also performed in an air environment (FIG. 25) by moving the entire spectroelectrochemistry set-up out of the glovebox.

FIG. 15 is an optical image of a VO₂nanocrystal film a) with and b) without electrochemical reduction in an electrolyte consisting of 0.1 M Li-TFSI. Panel c shows the electrochromic behavior in this case was irreversible as the Li+ ions that intercalate into the VO₂ lattice are unable to deintercalate.

FIG. 16 shows the spectroelectrochemistry of VO₂ nanocrystal films on ITO-coated glass in 0.1 M TBA-TFSI electrolyte. Darkening of NIR transmittance generated by applying −1.5 V vs NHE at 25° C. in argon with scans taken every 5 minutes for 30 minutes.

FIG. 17 shows the spectroelectrochemistry of VO₂nanocrystal films on ITO-coated glass in 0.1 M TBA-TFSI electrolyte. The effect of applied potential on the transmittance of 2000 nm light as a function of time at 25° C. in argon.

FIG. 18 shows the spectroelectrochemistry of VO₂ nanocrystal films on ITO-coated glass in 0.1 M TBA-TFSI electrolyte. Bleaching of NIR transmittance after applying −1.5 V vs NHE at 25° C. in argon starting at 30 minutes, with scans taken every 10 hours for 60 hours.

FIG. 19 shows the spectroelectrochemistry of VO₂ nanocrystal films on ITO-coated glass in 0.1 M TBA-TFSI electrolyte. Electrochromic behavior of VO₂nanocrystal films at 100° C. in argon. Films were brought to the rutile phase thermally before applying a reducing potential of −1.5 V vs NHE with traces taken every 5 minutes until saturation.

FIG. 20 shows a comparison of temperature (x-axis) vs, transmittance of near infrared light (at a wavelength of 2000 nm) (y-axis) for nanocrystalline VO₂ with no electrochemical bias and under applied biases between 0 and −1 V vs. NHE

FIG. 21 shows the transmittance as a function of wavelength at 30° C. showing initial monoclinic state, darkened state (reduced at −1 V for 3 hours), and recovered monoclinic state (oxidized at +1 V for 4 hours).

FIG. 22 shows the transmittance at 2000 nm and charge as a function of time as film is cycled between −1 V vs NHE for 3 hours and +1 V vs NHE for 4 hours at 30° C.

FIG. 23 shows the transmittance as a function of wavelength at 100° C. showing initial rutile state, bleached state (reduced at −1.5 V for 10 min), and recovered rutile state (oxidized at +1 V for 10 min).

FIG. 24 shows the transmittance at 2000 nm and charge as a function of time as film is cycled between −1.5 V and +1 V vs NHE for 10 minutes each at 100° C.

FIG. 25 shows a comparison of the electrochromic behavior of VO₂nanocrystal films in an argon (panel a, panel b) or air (panel c, panel d) environment at 30° C. For experiments in an air environment, the 0.1 M TBA-TFSI electrolyte was bubbled with air for 2 hours. The coloration efficiency was determined by taking the slope of the linear portion of the curve in panel b and panel d.

FIG. 26 shows the transmittance as a function of wavelength showing oxidation upon air exposure of a bleached film (reduced at −1.5 V at 100° C. for 10 min in an argon atmosphere).

FIG. 27 shows the transmittance at 2000 nm as a function of time during air exposure at room temperature. The bleached film undergoes an initial darkening during air oxidation, similar to the insulator-metal-insulator transformation seen upon electrochemical reduction.

FIG. 28 is an optical image with labels of the temperature dependent resistivity measurement set-up used in the manuscript. The entire apparatus was housed in androgen glovebox to minimize exposure to oxygen and water.

FIG. 29 shows the van der Pauw geometry resistivity measurements of unbiased, bleached (−1.5 V vs NHE at 100° C. in argon for 30 minutes) and darkened (−0.5 V vs NHE at 25° C. in argon for 17 hours) VO₂ films. All films were 107±3 nm thick.

FIG. 30 shows the temperature dependent optical transmittance data of the darkened films measured in the resistivity measurements of FIG. 29. During these optical measurements the films were immersed in 0.1 M TBA-TFSI in PC, but no bias was applied.

FIG. 31 shows the temperature dependent optical transmittance data of the bleached films measured in the resistivity measurements of FIG. 29. During these optical measurements the films were immersed in 0.1 M TBA-TFSI in PC, but no bias was applied.

FIG. 32 shows the normalized X-ray absorption spectroscopy data (panel a) and k³ extended X-ray absorption fine structure data (panel b) for monoclinic, rutile, darkening, bleaching, and bleached states of ex situ biased VO₂ nanocrystal films.

FIG. 33 shows the characterization of monoclinic, rutile, darkening, bleaching, and bleached states by Grazing-Incidence Wide Angle X-ray Scattering (GIWAXS) with the VO₂ monoclinic [ICSD collection code 15889] and VO₂ rutile [ICSD collection code 647637] patterns included for reference, and marked (*) peaks arising from background aluminum in the sample stage.

FIG. 34 shows the complete set of Grazing-Incidence Wide Angle X-ray Scattering measurements taken of ex situ biased VO₂nanocrystal films. The marked (*) peaks in the Grazing-Incidence Wide Angle X-ray Scattering data arise from background aluminum in the sample stage.

FIG. 35 shows close-up plots of each of the main peaks in the Grazing-Incidence Wide Angle X-ray Scattering data used to calculate a and c lattice parameters for a tetragonal pseudo-rutile structure, as well as schematics indicating each of these diffraction planes for rutile VO₂. The purple spheres are vanadium atoms and the red spheres are oxygen atoms. The VO₆ octahedron is highlighted with red planes, and each marked Miller plane is highlighted in a unique color. The marked (*) peaks in the Grazing-Incidence Wide Angle X-ray Scattering data arise from background aluminum in the sample stage.

FIG. 36 shows the Raman spectroscopy of unbiased and electrochemically reduced VO₂ films.

FIG. 37 shows the characterization of monoclinic, rutile, darkening, bleaching, and bleached states by X-ray absorption near edge spectroscopy of the V K-edge, with zoomed in views of the i) pre-edge feature and ii) absorption edge. The Fourier transformation of the k³ weighted extended X-ray absorption fine structure of the darkening state (lower left panel) and bleached (lower right panel) state with monoclinic and rutile shown in each for comparison.

FIG. 38 shows the fitted exponential time constants calculated for a two-time exponential model of the darkening (circles) and bleaching (squares) processes plotted as a function of Scherrer crystallite size. Time constants were fit to measurements of extinction at 2000 nm vs. time upon bleaching at −1.5 V in 0.1 M TBA-TFSI in PC in argon atmosphere at 25° C.

FIG. 39 shows the characterization of VO₂ films prepared from molecular clusters to generate planar films using an optical image of vanadium oxide molecular clusters prepared from various ratios of ammonium metavanadate and oxalic acid.

FIG. 40 shows the characterization of VO₂ films prepared from molecular clusters to generate planar films using an optical image of a film prepared by spin coating onto a conductive substrate before annealing.

FIG. 41 shows the characterization of VO₂ films prepared from molecular clusters to generate planar films using an optical image of a film prepared by spin coating onto a conductive substrate after annealing at 525° C. under partial oxygen pressures.

FIG. 42 shows the characterization of VO₂ films prepared from molecular clusters to generate planar films. X-ray diffraction (XRD) scan of the film after annealing.

FIG. 43 shows the characterization of VO₂ films prepared from molecular clusters to generate planar films. SEM micrograph of the film after annealing.

FIG. 44 shows the characterization of VO₂ films prepared from molecular clusters to generate planar films. Comparison of the MR modulation kinetics upon charging at −1.5 V vs NHE in 0.1 M TBA-TFSI in PC electrolyte at 25° C. in argon, between a planar film of VO₂ (dashed) and a VO₂ nanocrystal film (solid line), both on ITO-coated glass substrates.

FIG. 45 shows a comparison of the thermochromic (panel a, panel d) and electrochromic (panel b, panel c, panel e, panel f) properties of nanocrystalline (panel a, panel b, panel c) and planar (panel d, panel e, panel f) VO₂ films. This data demonstrates the enhanced electrochromic behavior of the VO₂ nanocrystal films compared to the planar VO₂ films.

FIG. 46 is a schematic illustrating the pathways to 4 distinct states of VO₂ NC films: (panel 1) The low-temperature, IR-transmitting insulating monoclinic state, (panel 2) an oxygen deficient, IR-blocking, metallic monoclinic state, (panel 3) an IR-transmitting, insulating expanded rutile-like structure, and (panel 4) the high-temperature, IR-blocking metallic rutile state. These states can be accessed via heating/cooling and electrochemical reduction/oxidation, denoted by arrows in the diagram. The purple spheres are vanadium atoms and red spheres are oxygen atoms, with open circles indicating oxygen vacancies.

### DETAILED DESCRIPTION

The devices and methods described herein may be understood more readily by reference to the following detailed description of specific aspects of the disclosed subject matter and the Examples included therein.

Before the present devices and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

By substantially the same is meant the values are within 5% of one another, e.g., within 3%, 2% or 1% of one another.

Eleetroehromie Devices

Disclosed herein are electrochromic devices. More specifically, according to the aspects illustrated herein, there are provided films exhibiting both electrochromic and thermochromic properties, and electrochromic/thermochromic device containing such films. In exemplary embodiments, the devices contain various functional layers including (1) a conducting layer, (2) a film exhibiting both electrochromic and thermochromic properties, (3) an electrolyte, (4) a counter layer, and (5) a second conducting layer. The disclosed devices can contain films of vanadium dioxide exhibiting both electrochromic and thermochromic properties. In certain aspects of the invention, nanocrystalline/nanostructured vanadium dioxide exhibiting both electrochromic and thermochromic properties is provided.

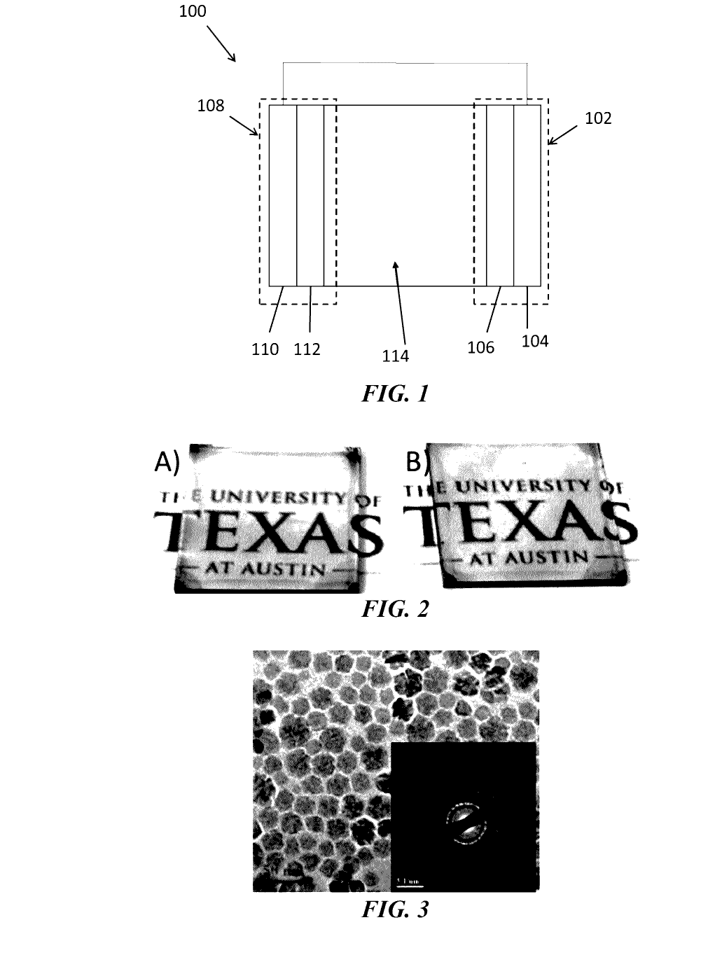

Referring now to FIG. 1, in some examples, the electrochromic devices 100 can comprise an electrochromic-thermochromic electrode 102 comprising a first conducting layer 104 and an electrochromic-thermochromic layer 106, wherein the first conducting layer 104 is in electrical contact with the electrochromic-thermochromic layer 106; a counter electrode 108 comprising a second conducting layer 110 and a counter layer 112, wherein the second conducting layer 110 is in electrical contact with the counter layer 112; and a non-intercalating electrolyte 114; wherein the first conducting layer 104 is in electrical contact with the second conducing layer 110; and wherein the electrochromic-thermochromic layer 106 and the counter layer 112 are in electrochemical contact with the non-intercalating electrolyte 114. The electrochromic device can, for example, comprise a touch panel, an electronic display, a transistor, a smart window, or a combination thereof.

Electrochromic-thermochromic layers can control optical properties such as optical transmission, absorption, reflectance, and/or emittance in a continual manner on application of a voltage and/or temperature. Electrochromic-thermochromic layers can also be used to reduce near infrared transmission. The electrochromic-thermochromic layers can comprise materials that exhibit both electrochromic and thermochromic properties.

In some examples, the electrochromic-thermochromic layer can transition from different optical states upon application of a potential to the electrochromic-thermochromic electrode and/or by heating the electrochromic-thermochromic electrode. For example, the electrochromic-thermochromic can have a first optical state and a second optical state, wherein each of the first optical state and the second optical state has an average transmittance at one or more wavelengths from 400 to 2200 nm, wherein the average transmittance at the second optical state is less than the average transmittance of the first optical state by 20% or more (e.g., 25% or more, 30% or more, 35% or more, 40% or more, 45% or more, 50% or more, 55% or more, 60% or more, 65% or more, 70% or more, 75% or more, 80% or more, 85% or more, 90% or more, or 95% or more) at one or more wavelengths from 400 nm to 2200 nm. The use of the terms first and second here is not intended to imply that there are only two distinct optical states, but rather that the electrochroinic-thermochromic layer can change between different optical states.

In some examples, the electrochromic-thermochromic layer can be switched from the first optical state to the second optical state upon application of a potential to the electrochromic-thermochromic electrode. In some examples, the potential applied to the electrochromic-thermochromic electrode can be −0.1 V vs. a normal hydrogen electrode (NHE) or less (e.g., −0.25 V or less, −0.5 V or less, −0.75 V or less, −1 V or less, −1.25 V or less, −1.5 V or less, −1.75 V or less, −2 V or less, −2.25 V or less, −2.5 V or less, or 2.75 V or less). In some examples, the potential applied to the electrochromic-thermochromic electrode can be −3 V vs. NHE or more (e.g., −2.75 V or more, −2.5 V or more, −2.25 V or more, −2 V or more, −1.75 V or more, −1.5 V or more, −1.25 V or more, −1 V or more, −0.75 V or more, −0.5 V or more, or −0.25 V or more). The potential applied to the electrochromic-thermochromic electrode can range from any of the minimum values described above to any of the maximum values described above. For example, the potential applied to the electrochromic-thermochromic electrode can be from −0.1 V to −3 V (e.g., from −0.1 V to −1.5 V, from −1.5 V to −3 V, from −0.1 V to −1 V, from −1 V to −2 V, from −2 V to −3 V, or from −1.5 V to −2.5 V). In some examples, the potential can be applied to the electrochromic-thermochromic electrode for an amount of time of 1 second or more (e.g., 5 seconds or more, 10 seconds or more, 15 seconds or more, 30 seconds or more, 45 seconds or more, 1 minute or more, 2 minutes or more, 3 minutes or more, 4 minutes or more, 5 minutes or more, 10 minutes or more, 15 minutes or more, 30 minutes or more, 45 minutes or more, 1 hour or more, 2 hours or more, 3 hours or more, 4 hours or more, 5 hours or more, 6 hours or more, 8 hours or more, 10 hours or more, 12 hours or more, 14 hours or more, 16 hours or more, 18 hours or more, 20 hours or more, or 22 hours or more). In some examples, the potential can be applied to the electrochromic-thermochromic electrode for an amount of time of 24 hours or less (e.g., 22 hours or less, 20 hours or less, 18 hours or less, 16 hours or less, 14 hours or less, 12 hours or less, 10 hours or less, 8 hours or less, 6 hours or less, 5 hours or less, 4 hours or less, 3 hours or less, 2 hours or less, 1 hour or less, 45 minutes or less, 30 minutes or less, 15 minutes or less, 10 minutes or less, 5 minutes or less, 4 minutes or less, 3 minutes or less, 2 minutes or less, 1 minute or less, 45 seconds or less, 30 seconds or less, 15 seconds or less, 10 seconds or less, or 5 seconds or less). The amount of time that the potential is applied to the electrochromic-thermochromic electrode can range from any of the minimum values described above to any of the maximum values described above. For example, the potential can be applied to the electrochromic-thermochromic electrode for an amount of time of from 1 second to 24 hours (e.g., from 1 second to 12 hours, from 12 hours to 24 hours, from 1 second to 18 hours, from 1 second to 6 hours, from 1 second to 1 hour, from 1 second to 30 minutes, from 1 second to 10 minutes, from 1 second to 1 minute, or from 10 minutes to 1 hour).

In some examples, the electrochromic-thermochromic layer can further have a third optical state, wherein the third optical state has an average transmittance at one or more wavelengths from 400 to 2200 nm, wherein the average transmittance at the second optical state is less than the average transmittance of the third optical state by 20% or more (e.g., 25% or more, 30% or more, 35% or more, 40% or more,45% or more, 50% or more, 55% or more, 60% or more, 65% or more, 70% or more, 75% or more, 80% or more, 85% or more, 90% or more, or 95% or more) at one or more wavelengths from 400 nm to 2200 nm.

In some examples, the electrochromic-thermochromic layer can be switched from the second optical state to the third optical upon application of a potential to the electrochromic-thermochromic electrode. In some examples, the potential applied to the electrochromic-thermochromic electrode can be −0.1 V vs. a normal hydrogen electrode (NHE) or less (e.g., −0.25 V or less, −0.5 V or less, −0.75 V or less, −1 V or less, −1.25 V or less, −1.5 V or less, −1.75 V or less, −2 V or less, −2.25 V or less, −2.5 V or less, or 2.75 V or less). In some examples, the potential applied to the electrochromic-thermochromic electrode can be −3 V vs. NHE or more (e.g., −2.75 V or more, −2.5 V or more, −2.25 V or more, −2 V or more, −1.75 V or more, −1.5 V or more, −1.25 V or more, −1 V or more, −0.75 V or more, −0.5 V or more, or −0.25 V or more). The potential applied to the electrochromic-thermochromic electrode can range from any of the minimum values described above to any of the maximum values described above. For example, the potential applied to the electrochromic-thermochromic electrode can be from −0.1 V to −3 V (e.g., from −0.1 V to −1.5 V, from −1.5 V to −3 V, from −0.1 V to −1 V, from −1 V to −2 V, from −2 V to −3 V, or from −1.5 V to −2.5 V). In some examples, the potential can be applied to the electrochromic-thermochromic electrode for an amount of time of 1 second or more (e.g., 5 seconds or more, 10 seconds or more, 15 seconds or more, 30 seconds or more, 45 seconds or more, 1 minute or more, 2 minutes or more, 3 minutes or more, 4 minutes or more, 5 minutes or more, 10 minutes or more, 15 minutes or more, 30 minutes or more, 45 minutes or more, 1 hour or more, 2 hours or more, 3 hours or more, 4 hours or more, 5 hours or more, 6 hours or more, 8 hours or more, 10 hours or more, 12 hours or more, 14 hours or more, 16 hours or more, 18 hours or more, 20 hours or more, or 22 hours or more), in some examples, the potential can be applied to the electrochromic-thermochromic electrode for an amount of time of 24 hours or less (e.g., 22 hours or less, 20 hours or less, 18 hours or less, 16 hours or less, 14 hours or less, 12 hours or less, 10 hours or less, 8 hours or less, 6 hours or less, 5 hours or less, 4 hours or less, 3 hours or less, 2 hours or less, 1 hour or less, 45 minutes or less, 30 minutes or less, 15 minutes or less, 10 minutes or less, 5 minutes or less, 4 minutes or less, 3 minutes or less, 2 minutes or less, 1 minute or less, 45 seconds or less, 30 seconds or less, 15 seconds or less, 10 seconds or less, or 5 seconds or less). The amount of time that the potential is applied to the electrochromic-thermochromic electrode can range from any of the minimum values described above to any of the maximum values described above. For example, the potential can be applied to the electrochromic-thermochromic electrode for an amount of time of from 1 second to 24 hours (e.g., from 1 second to 12 hours, from 12 hours to 24 hours, from 1 second to 18 hours, from 1 second to 6 hours, from 1 second to 1 hour, from 1 second to 30 minutes, from 1 second to 10 minutes, from 1 second to 1 minute, or from 10 minutes to 1 hour).

The electrochromic-thermochromic layer can, for example have a thickness of 30 nanometers (nm) or more (e.g., 40 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, or 275 nm or more). In some examples, the electrochromic-thermochromic layer can have a thickness of 300 nm or less (e.g., 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, or 40 nm or less). The thickness of the electrochromic-thermochromic layer can range from any of the minimum values described above to any of the maximum values described above. For example, the electrochromic-thermochromic layer can have a thickness of from 30 nm to 300 nm (e.g., from 30 nm to 150 nm, from 150 nm to 300 nm, from 30 nm to 100 nm, from 100 nm to 200 nm, from 200 nm to 30 nm, or from 100 nm to 300 nm).

In some examples, the electrochromic-thermochromic layer comprises a nanostructured film. As used herein, “nanostructured” means any structure with one or more nanosized features. A nanosized feature can be any feature with at least one dimension less than 1 micrometer (μm) in size. For example, a nanosized feature can comprise a nanowire, nanotube, nanoparticle, nanopore, and the like, or combinations thereof. As such, the nanostructured material can comprise, for example, a nanowire, nanotube, nanoparticle, nanopore, or a combination thereof. In some examples, the nanostructured material can comprise a material that is not nanosized but has been modified with a nanowire, nanotube, nanoparticle, nanopore, or a combination thereof.

In some examples, the nanostructured electrochromic-thermochromic layer can be characterized by a relatively high surface area. The nanostructured electrochromic-thermochromic layer can be arrayed in a lattice or framework that is characterized by the presence of open pores. For example, the electrochromic-thermochromic layer comprises a nanocrystalline material permeated by a plurality of pores (e.g., a porous nanocrystalline material). The nanostructured electrochromic-thermochromic layer can be characterized by a relatively high surface area. In some examples, the electrochromic-thermochromic layer can comprise a material that is arrayed in a lattice or framework that is characterized by the presence of a plurality of pores e.g., a plurality of open pores). The plurality of pores can have an average pore size. As used herein “pore size” refers to the largest cross-sectional dimension of a pore in a plane perpendicular to the longitudinal axis of the pore. The longitudinal axis of the pore refers to the longest axis of a pore. For example, in the case of a substantially cylindrical pore in the porous nanocrystalline material, the pore size would be the diameter of the pore. The average pore size can be determined, for example, using electron microscopy (e.g., scanning electron microscopy (SEM), transmission electron microscopy (TEM), high-resolution TEM (HRTEM), scanning transmission electron microscopy (STEM)), Brunauer-Emmett-Teller (BET) measurements, porosimetry, or a combination thereof.

In some examples, the average pore size for the plurality of pores can be 0.05 nm or more as determined by porosimetry (e.g., 0.1 nm or more, 0.25 nm or more, 0.5 nm or more, 1 nm or more, 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, or 90 nm or more). In some examples, the average pore size for the plurality of pores can be 100 nm or less as determined by porosimetry (e.g., 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, 3 nm or less, 2 nm or less, 1 nm or less, 0.5 nm or less, 0.25 nm or less, or 0.1 nm or less). The average pore size for the plurality of pores can range from any of the minimum values described above to any of the maximum values described above. For example, the average pore size for the plurality of pores can be from 0.05 nm to 100 nm as determined by porosimetry (e.g., from 0.05 nm to 50 nm, from 50 nm to 100 nm, from 0.1 nm to 100 nm, from 0.1 nm to 90 nm, from 0.1 nm to 80 nm, from 0.1 nm to 70 nm, from 0.1 nm to 60 nm, from 0,1 nm to 50 nm, from 0.5 nm to 100 nm, from 0.5 nm to 90 nm, from 0.5 nm to 80 nm, from 0.5 nm to 70 nm, from 0.5 nm to 60 nm, from 0.5 nm to 50 nm, from 0.5 nm to 40 nm, from 0.5 nm to 30 nm, from 0.5 nm to 20 nm, from 0.5 nm to 10 nm, from 1 nm to 10 nm, from 1 nm to 9 nm, from 1 nm to 8 nm, from 1 nm to 7 nm, from 1 nm to 6 nm, from 1 nm to 5 nm, or from 2 nm to 5 nm).

In some examples, the electrochromic-thermochromic layer comprises a porous nanocrystalline material, the porous nanocrystalline material comprising a plurality of nanocrystals. The plurality of nanocrystals can have an average particle size, “Average particle size” and “mean particle size” are used interchangeably herein, and generally refer to the statistical mean particle size of the nanocrystals in a population of nanocrystals. For example, the average particle size for a plurality of nanocrystals with a substantially spherical shape can comprise the average diameter of the plurality of nanocrystals. For a nanocrystal with a substantially spherical shape, the diameter of a nanocrystal can refer, for example, to the hydrodynamic diameter. As used herein, the hydrodynamic diameter of a nanocrystal can refer to the largest linear distance between two points on the surface of the nanocrystal. For an anisotropic nanocrystal, the average particle size can refer to, for example, the average maximum dimension of the nanocrystal (e.g., the length of a rod shaped particle, the diagonal of a cube shape particle, the bisector of a triangular shaped particle, etc.) For an anisotropic nanocrystal, the average particle size can refer to, for example, the hydrodynamic size of the nanocrystal. Mean particle size can be measured using methods known in the art, such as evaluation by scanning electron microscopy, transmission electron microscopy, and/or dynamic light scattering.

The plurality of nanocrystals can, for example, have an average particle size of 5 nm or more (e.g., 6 nm or more, 7 nm or more, 8 nm or more, 9 nm or more, 10 nm or more, 15 nm or more, 20 nm or more, 25 nm or more, 30 nm or more, 35 nm or more, 40 nm or more, or 45 nm or more). In some examples, the plurality of nanocrystals can have an average particle size of 50 nm or less e.g., 45 nm or less, 40 nm or less, 35 nm or less, 30 nm or less, 25 nm or less, 20 nm or less, 15 nm or less, 10 nm or less, 9 nm or less, 8 nm or less, 7 nm or less, or 6 nm or less). The average particle size of the plurality of nanocrystals can range from any of the minimum values described above to any of the maximum values described above. For example, the plurality of nanocrystals can have an average particle size of from 5 nm to 50 nm (e.g., from 5 nm to 25 from 25 nm to 50 from 5 nm to 15 nm, from 15 nm to 30 nm, form 30 nm to 50 nm, or from 10 nm to 40 nm).

In some examples, the plurality of nanocrystals can be substantially monodisperse. “Monodisperse” and “homogeneous size distribution,” as used herein, and generally describe a population of nanocrystals where all of the nanocrystals are the same or nearly the same size. As used herein, a monodisperse distribution refers to nanocrystal size distributions in which 70% of the distribution (e.g., 75% of the distribution, 80% of the distribution, 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

The plurality of nanocrystals can comprise nanocrystals of any shape (e.g., sphere, rod, cube, rectangle, octahedron, truncated octahedron, plate, cone, prism, ellipse, triangle, etc.). In some examples, the plurality of nanocrystals can have an isotropic shape. In some examples, the plurality of nanocrystals can have an anisotropic shape.

The electrochromic-thermochromic layer can comprise a material exhibiting electrochromic and thermochromic behavior. In an exemplary embodiment, the film having both electrochromic and thermochromic properties contains a vanadium oxide compound. In certain embodiments, the electrochromic-thermochromic layer having both electrochromic and thermochromic properties contains a vanadium (IV) dioxide compound. In some examples, the electrochromic-thermochromic layer comprises VO₂. Vanadium dioxide (VO₂) undergoes significant optical, electronic, and structural changes as it transforms between the low-temperature monoclinic and high-temperature rutile phases. More recently, alternative stimuli have been utilized to trigger insulator to metal transformations in VO₂, including electrochemical gating.

In some examples, the coating having both electrochromic and thermochromic properties contains a nanostructured vanadium oxide compound. The nanostructured vanadium dioxide film can be characterized by a relatively high surface area relative to previous forms of vanadium dioxide. The vanadium dioxide can be arrayed in a lattice or framework that is characterized by the presence of open pores. In some examples, the electrochromic-thermochromic material comprises porous nanocrystalline VO₂. In some examples, the porous nanocrystalline VO₂ can have a thickness of from 30 nm to 300 nm (e.g., from 100 nm to 300 nm). In some examples, the porous nanocrystalline VO₂ can have a plurality of pores having an average pore size of from 0.05 nm to 100 nm as determined by porosimetry (e.g., from 2 nm to 5 nm). In some examples, the porous nanocrystalline VO₂ can comprise a plurality of nanocrystals having an average particle size of from 5 nm to 50 nm.

The electrochromic devices further comprise a non-intercalating electrolyte. As used herein a “non-intercalating electrolyte” refers to an electrolyte whose ions do not substantially intercalate within the electrochromic-thermochromic layer. As used herein, “intercalate” refers to the incorporation of the electrolyte ion within the crystalline structure of the electrochromic-thermochromic layer. In certain examples, the non-intercalating electrolyte comprises ions that do not substantially intercalate within the vanadium dioxide forming the electrochromic-thermochromic layer (e.g., the electrolyte ions are not incorporated within the crystalline structure of the vanadium dioxide forming the electrochromic-thermochromic layer).

The non-intercalating electrolyte can comprise a cationic moiety and an anionic moiety. In some examples, the non-intercalating electrolyte can contain a compound of formula I^{cat+}I^{anion-}, wherein I^{cat+} represents a cationic moiety and I^{anion-} represents an anionic moiety. The cationic moiety is sufficiently large as to not intercalate the electrochromic-thermochromic layer. In some examples, the cationic moiety of the non-intercalating electrolyte has an atomic radius of 2 Å or more (e.g., 2.1 Å or more, 2.2 Å or more, 2.3 Å or more, 2.4 Å or more, 2.5 Å or more, 3 Å or more, 3.5 Å or more, 4 Å or more, 4.5 Å or more, 5 Å or more, 5.5 Å or more, or 6 Å or more).

Particular examples of cationic moieties that can be present in the non-intercalating electrolytes include compounds that contain nitrogen, phosphorus, or a boron heteroatom. Nitrogen atom-containing groups can exist as a neutral compound or can be converted to a positively-charged quaternary ammonium species, for example, through alkylation or protonation of the nitrogen atom. Thus, compounds that possess a quaternary nitrogen atom (known as quaternary ammonium compounds (QACs)) are typically cations. According to the devices and methods disclosed herein, any compound that contains a quaternary nitrogen atom or a nitrogen atom that can be converted into a quaternary nitrogen atom (cation precursor) can be a suitable cation for the disclosed non-intercalating electrolytes.

In some examples, phosphorous atoms can exist as a charged phosphonium species, for example, through alkylation of the phosphorous atom. Thus, compounds that possess a quaternary phosphorous atom (known as quaternary phosphonium compounds) are typically cations. According to the devices and methods disclosed herein, any compound that contains a quaternary phosphorus atom or a phosphorus atom that can be converted into a quaternary phosphonium atom can be a suitable cation for the disclosed non-intercalating electrolytes.

In some examples, sulfur atoms can exist as a charged sulfonium species, for example, through alkylation of the sulfurous atom. Thus, compounds that possess a ternary sulfurous atom are typically cations. According to the devices and methods disclosed herein, any compound that contains a ternary sulfurous atom or a sulfurous atom that can be converted into a ternary sulfurous atom can he a suitable cation for the non-intercalating electrolytes.

In some examples, the cationic moiety can comprise an ion selected from the group of R₄N⁺, R₄P⁺, R₄B⁻, Rb⁺, Cs⁺, Sr²⁺, Ba²⁺, Ca²⁺, K⁺, and combinations thereof, wherein R is any non-hydrogen functional group. In certain embodiments, R can be hydrogen, while in other embodiments R can be any non-hydrogen functional group. In some examples, each R is independently a hydrogen or C₁-C₁₂ aliphatic group. The C₁-C₁₂ aliphatic group can be any alkyl, alkenyl, alkynyl, heteroalkyl, heteroalkenyl, heteroalkynyl, cycloalkyl, cycloalkenyl, heterocycloalkyl, or heterocycloalkenyl group, as described herein. For example, the aliphatic moiety can include substituted or unsubstituted C₁₋₁₂alkyl, substituted or unsubstituted C₂₋₁₂ alkenyl, substituted or unsubstituted C₂₋₁₂ alkynyl, substituted or unsubstituted C₁₋₁₂ heteroalkyl substituted or unsubstituted C₂₋₁₂ heteroalkenyl, or substituted or unsubstituted C₂₋₁₂ heteroalkynyl groups. Generally, the aliphatic moiety can comprise 1 or more, 2 or more, 3 or more, 4 or more, 5 or more, or 6 or more carbon atoms. In other examples, the aliphatic moiety can comprise a mixture of aliphatic groups having a range of carbon atoms. For example, the aliphatic moiety can comprise from 1 to 20, from 1 to 18, from 1 to 15, from 1 to 10, or from 1 to 6 carbon atoms. In some specific examples, the aliphatic moiety can contain 1, 2, 3, 4, 5, 6, 7, 8, 9, 10, 11, or 12 carbon atoms, where any of the stated values can form an upper or lower endpoint when appropriate. Examples of specific aliphatic moieties that can be used include, but are not limited to, methyl, ethyl, propyl, 1-methylethyl (isopropyl), cyclopropyl, butyl, 1-methylpropyl (sec-butyl), 2-methylpropyl (isobutyl), 1,1-dimethylethyl (tert-butyl), cyclobutyl, pentyl, 1-methylbutyl, 2-methylbutyl, 3-methylbutyl, 2,2-dimethylpropyl, 1-ethylpropyl, cyclopentyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, cyclohexyl, benzyl, pheynyl, heptyl, octyl, 2-ethylhexyl, nonyl, naphthyl, decyl, and dodecyl (lauryl) groups, including branched derivatives thereof and any mixtures thereof. The aliphatic moieties can further include alkoxymethyl groups containing from 2 to 11 carbon atoms) or methyl groups (e.g., containing from 5 to 11 carbon atoms). In the aliphatic heteroaryl cations, the aliphatic moiety is bonded to a heteroatom in the heteroaryl moiety. In some embodiments, two or more of the R groups optionally combine to form a ring. In some examples, one or more of the R groups can be methyl, ethyl, propyl, or butyl. In some examples, two or more of the R groups can combine to form a ring, the ring including between 3 and 12 atoms. In some examples, two or more of the R groups can combine to form a ring, the ring including at least one double bond. In some embodiments, all the R groups in the cationic moiety can be same, for instance, (CH₃)₄N⁺, while in other embodiments, the R groups are not identical, for instance (CH₃CH₂)₃N⁺CH₃. In some embodiments, two or more R groups can together form a ring, for instance N-methylquinuclidinium.

In certain embodiments, the cationic moiety can be an ion of R₄N⁺, wherein each R is independently a C₁₋₁₂ aliphatic group. Exemplary cationic moieties can include (CH₃)₄N⁺, (Et)₄N⁺, (n-Bu)₄N⁺, (CH₃)₃PhN⁺, (Et)₃BnN⁺, N,N-dimethylpyrollidinium, N-butyl,N-methylpyrollidinium, and N,N-dimethylpiperidinium.

The anionic moiety can comprise any suitable counter ion to the cationic moiety (e.g., any suitable anionic moiety to balance the cationic moiety). In some embodiments the anionic moiety does not intercalate the electrochromic-thermochromic layer. In some embodiments, anionic moiety does not intercalate the nanostructured vanadium dioxide forming the electrochromic-thermochromic layer.

In certain embodiments, the anion can be a weakly coordinating anion such as a borate, sulfonate, phosphonate, imitate, antimonite, aluminate, acetate, and the like. Exemplary anions include tetrafluoroborate, tetrakis(pentalluorophenyl borate), hexafluorophospate, perchlorate, bis(trifluoromethyl)sulfonyl)imidate (“bistritlide”), hexafluoroanitmonate, tetrachloroaluminate, trifluoromethylsulfonate, trilluoroacetate, o-tolylsulfonate, and combinations thereof.

In other embodiments the non-intercalating electrolyte can comprise an ionic liquid. An ionic liquid is an ionic salt which has a melting point below or close to room temperature. Exemplary ionic liquids include n-butyl-3-methylimidazolium methanesulfonate, 1-butyl-1 methylpyrrolidinium chloride, ethyl-4-methylmorpholinium methyl carbonate, 4-(3-butyl-1-imidazolio)-1-butane sulfonate and 3-(1-methyl-3-imidazolio)propanesulfonate.

The non-intercalating electrolyte can, in some examples, further comprise a solvent, which can be either aqueous or organic. Exemplary solvents include ethereal solvents such as THF, glyme and diglyme, as well as carbonyl-containing solvents such as propylene carbonate and DMF. Other solvents include polymeric compounds such as polyethylene glycol and methoxypolyethylene glycol.

In certain embodiments, the non-intercalating electrolyte can be in the form of a gel. Suitable gels can he obtained by combining polymers and ionic liquids, or ionic liquids and a compound of formula I^{cat+}I^{anion-}, or polymers and solvents with a compound of formula I^{cat+}I^{anion-}.

The first conducting layer and/or the second conducting layer can comprise(s) a transparent conducting oxide, a conducting polymer, a carbon material, a nanostructured metal, or a combination thereof. The nanostructured metal can comprise, for example, a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

Examples of carbon materials include, but are not limited to, graphitic carbon and graphites, including pyrolytic graphite (e.g., highly ordered pyrolytic graphite (HOPG)) and isotropic graphite, amorphous carbon, carbon black, single- or multi-walled carbon nanotubes, graphene, glassy carbon, diamond-like carbon (DLC) or doped DLC, such as boron-doped diamond, pyrolyzed photoresist films, and others known in the art.

In some examples, the first conducting layer and/or the second conducting layer can comprise a transparent conducting oxide. In some examples, the first conducting layer and/or the second conducting layer can comprise a metal oxide. Examples of metal oxides include simple metal oxides (e.g., with a single metal element) and mixed metal oxides (e.g., with different metal elements). The metal oxide can, for example, comprise a metal selected from the group consisting of Cd, Cr, Cu, Ga, In, Ni, Sn, Ti, W, Zn, and combinations thereof. In some examples, the conducting layer can comprise CdO, CdIn₂O₄, Cd₂SnO₄, Cr₂O₃, CuCrO₂, CuO₂, Ga₂O₃, In₂O₃, NiO, SnO₂, TiO₂, ZnGa₂O₄, ZnO, InZnO, InGaZnO, InGaO, ZnSnO, Zn₂SnO₄, CdSnO, WO₃, or combinations thereof.

In some examples, the first conducting layer and/or the second conducting layer can further comprise a dopant. The dopant can comprise any suitable dopant for the first conducting layer and/or the second conducting layer can. The dopant can, for example, be selected to tune the optical and/or electronic properties of the nanostructured conducting film.

In some examples, the first conducting layer and/or the second conducting layer can comprise a transparent conducting oxide selected from indium doped tin oxide, tin doped indium oxide, fluorine doped tin oxide, and combinations thereof.

The first conducting layer and/or the second conducting layer can, for example, comprise indium tin oxide, fluorine tin oxide, antimony doped tin oxide, indium zinc oxide, polyacetylene, polyalanine, poly(3,4-ethylenedioxythiophene) polystyrene sulfonate (“PEDOT-PSS”), graphene, carbon nanorods, metal nanowires, or combinations thereof.

In certain embodiments, the first and second conducting layers can be the same, while in other embodiments, the first conductive layer is different than the second conductive layer.

The counter layer can comprise any suitable charge storage material. Suitable charge storage materials include conductive transition metal oxides. In certain embodiments, the counter layer includes a doped metal oxide. Exemplary transition metal oxides include nickel oxide, vanadium oxide, indium oxide, iridium oxide, mixed nickel titanium oxide, titanium oxide, zirconium oxide, cerium oxide, zinc oxide, mixed zirconium-cerium oxide, and mixtures thereof. The counter layer can also include Prussian blue and related compounds.

The electrochromic devices described herein can be coupled to a power supply and optionally to one or more additional suitable features including, but not limited to, a voltmeter, an ammeter, a multimeter, an ohmmeter, a signal generator, a pulse generator, an oscilloscope, a frequency counter, a potentiostat, a capacitance meter, or a reference electrode. For example, the electrochromic device can further comprise a power supply that is in electrical contact with the electrochromic-thermochromic electrode and the counter electrode. In some examples, the power supply is configured to apply a potential to the electrochromic-thermochromic electrode, the counter electrode, or a combination thereof.

In some examples, the electrochromic devices can further comprises a light source configured to illuminate at least a portion of the electrochromic device. For example, the light source can be configured to illuminate at least a portion of the electrochromic-thermochromic electrode, the counter electrode, or a combination thereof. The light source can be any type of light source. In some examples, the electrochromic devices can include a single light source. In other examples, more than one light source can be included in the electrochromic devices. Examples of suitable light sources include natural light sources (e.g., sunlight) and artificial light sources (e.g., incandescent light bulbs, light emitting diodes, gas discharge lamps, arc lamps, lasers etc.). In some examples, the light source can emit electromagnetic radiation at a wavelength that overlaps with at least a portion of the bandgap of the electrochromic-thermochromic layer.

Methods of Making

Also disclosed herein are methods of making the electrochromic devices described herein.

Also disclosed herein are methods of making films containing nanostructured/nanocrystalline vanadium dioxide exhibiting both electrochromic and thermochromic properties, and methods of making devices containing such films.

For example, also described herein are methods of making the electrochromic-thermochromic electrodes described herein. The methods of making the electrochromic-thermochromic electrodes can, for example, comprise dispersing a plurality of nanocrystals in a solution, thereby forming a mixture; depositing the mixture on the first conducting layer, thereby forming a precursor layer on the first conducting layer; and thermally annealing the precursor layer in the presence of oxygen, thereby forming the electrochromic-thermochromic layer. Depositing the mixture can, for example, comprise printing, lithographic deposition, spin coating, drop-casting, zone casting, dip coating, blade coating, spraying, vacuum filtration, slot die coating, curtain coating, or combinations thereof.

The plurality of nanocrystals can comprise, for example, V₂O₃. In some examples, the plurality of nanocrystals have an average particle size of from 5 nm to 50 nm. In some examples, the methods can further comprise forming the plurality of nanocrystals.

Thermally annealing the precursor layer can, for example, comprise heating the precursor layer at a temperature of 100° C. or more (e.g., 150° C. or more, 200° C. or more, 250° C. or more, 300° C. or more, 350° C. or more, 400° C. or more, or 450° C. or more). In some examples, thermally annealing the precursor layer can comprise heating the precursor layer at a temperature of 500° C. or less (e.g., 450° C. or less, 400° C. or less, 350° C. or less, 300° C. or less, 250° C. or less, 200° C. or less, or 150° C. or less). The temperature at which the precursor layer is heated to thermally anneal the precursor layer can range from any of the minimum values described above to any of the maximum values described above. For examples, thermally annealing the precursor layer can comprise heating the precursor layer at a temperature of from 100° C. to 500° C. (e.g., from 100° C. to 250° C., from 250° C. to 500° C., from 100° C. to 200° C., from 200° C. to 300° C., from 300° C. to 400° C., from 400° C. to 500° C., from 200° C. to 500° C., from 300° C. to 500° C., or from 300° C. to 400° C.).

In some examples, the precursor layer is thermally annealed for 1 minute or more (e.g., 5 minutes or more, 10 minutes or more, 15 minutes or more, 20 minutes or more, 25 minutes or more, 30 minutes or more, 40 minutes or more, 50 minutes or more, 1 hour, or more, 1.5 hours or more, 2 hours or more, 2.5 hours or more, 3 hours or more, 3.5 hours or more, 4 hours or more, 4.5 hours or more, 5 hours or more, 6 hours or more, 7 hours or more, 8 hours or more, 9 hours or more, 10 hours or more, 11 hours or more, 12 hours or more, 18 hours or more, 24 hours or more, or 36 hours or more). In some examples, the precursor layer is thermally annealed for 48 hours or less (e.g., 36 hours or less, 24 hours or less, 18 hours or less, 12 hours or less, 11 hours or less, 10 hours or less, 9 hours or less, 8 hours or less, 7 hours or less, 6 hours or less, 5 hours or less, 4.5 hours or less, 4 hours or less, 3.5 hours or less, 3 hours or less, 2.5 hours or less, 2 hours or less, 1.5 hours or less, 1 hour or less, 50 minutes or less, 40 minutes or less, 30 minutes or less, 25 minutes or less, 20 minutes or less, 15 minutes or less, 10 minutes or less, or 5 minutes or less). The time that the precursor layer is thermally annealed for can range from any of the mini MUM values described above to any of the maximum values described above. For example, the precursor layer can be thermally annealed for from 1 minute to 48 hours (e.g., from 1 minute to 24 hours, from 1 minute to 12 hours, from 1 minute to 6 hours, from 1 minute to 3 hours, from 10 minutes to 2.5 hours, from 20 minutes to 2 hours, or from 30 minutes to 1.5 hours).

The precursor layer is thermally annealed in the presence of oxygen. The oxygen can be present, for example, at a concentration of 10 ppm or more during the thermal annealing of the precursor layer (e.g., 20 ppm or more; 30 ppm or more; 40 ppm or more; 50 ppm or more; 60 ppm or more; 70 ppm or more; 80 ppm or more; 90 ppm or more; 100 ppm or more; 125 ppm or more; 150 ppm or more; 175 ppm or more; 200 ppm or more; 225 ppm or more; 250 ppm or more; 275 ppm or more; 300 ppm or more; 350 ppm or more; 400 ppm or more; 450 ppm or more; 500 ppm or more; 600 ppm or more; 700 ppm or more; 800 ppm or more; 900 ppm or more; 1,000 ppm or more; 1,500 ppm or more; 2,000 ppm or more; 2,500 ppm or more; 3,000 ppm or more; 3,500 ppm or more; 4,000 ppm or more; 4,500 ppm or more; 5,000 ppm or more; 6,000 ppm or more; 7,000 ppm or more; 8,000 ppm or more; or 9,000 ppm or more).

In some examples, the oxygen can be present at a concentration of 10,000 ppm or less during the thermal annealing of the precursor layer (e.g., 9,000 ppm or less; 8,000 ppm or less; 7,000 ppm or less; 6,000 ppm or less; 5,000 ppm or less; 4,500 ppm or less; 4,000 ppm or less; 3,500 ppm or less; 3,000 ppm or less; 2,500 ppm or less; 2,000 ppm or less; 1,500 ppm or less; 1,000 ppm or less; 900 ppm or less; 800 ppm or less; 700 ppm or less; 600 ppm or less; 500 ppm or less; 450 ppm or less; 400 ppm or less; 350 ppm or less; 300 ppm or less; 275 ppm or less; 250 ppm or less; 225 ppm or less; 200 ppm or less; 175 ppm or less; 150 ppm or less; 125 ppm or less; 100 ppm or less; 90 ppm or less; 80 ppm or less; 70 ppm or less; 60 ppm or less; 50 ppm or less; 40 ppm or less; 30 ppm or less; or 20 ppm or less).

The concentration of oxygen present during the thermal annealing of the precursor layer can range from any of the minimum values described above to any of the maximum values described above. For example, the oxygen can be present at a concentration of from 10 ppm to 10,000 ppm during the thermal annealing of the precursor layer (e.g., from 10 ppm to 5,000 ppm; from 5,000 ppm to 10,000 ppm; from 10 ppm to 2,500 ppm; from 10 ppm to 1,000 ppm; from 10 ppm to 750 ppm; from 50 ppm to 750 ppm; from 50 ppm to 500 ppm; from 50 ppm to 400 ppm; from 100 ppm to 400 ppm; or from 100 ppm to 300 ppm).

Also described herein are methods of making the counter electrodes described herein. For example, the method of making the counter electrode can comprise depositing the counter layer on the second conducting layer. Depositing the counter layer can, for example, comprise atomic layer deposition, chemical vapor deposition, electron beam evaporation, thermal evaporation, sputtering deposition, pulsed laser deposition, printing, lithographic deposition, spin coating, drop-casting, zone casting, dip coating, blade coating, spraying, vacuum filtration, slot die coating, curtain coating, or combinations thereof.

Methods of Use

Also provided herein are methods of use of the electrochromic devices described herein. For example, the electrochromic devices described herein can be used in, for example, touch panels, electronic displays, transistors, smart windows, or a combination thereof. Such devices can be fabricated by methods known in the art.

In some examples, the electrochromic devices described herein can be used in various articles of manufacture including electronic devices, energy storage devices, energy conversion devices, optical devices, optoelectronic devices, or combinations thereof Examples of articles of manufacture (e.g., devices) using the electrochromic devices described herein can include, but are not limited to touch panels, electronic displays, transistors, smart windows, solar cells, fuel cells, photovoltaic cells, and combinations thereof. Such articles of manufacture can be fabricated by methods known in the art.

The examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Bulk vanadium dioxide (VO₂) undergoes a reversible metal-to-insulator transition (MIT) at approximately 68° C., at which point the low-temperature monoclinic phase transforms to the high-temperature rutile phase (Morin F J. Phys. Rev. Lett. 1959, 3, 34-36). This structural transformation is accompanied by changes in the oxide's electronic and near infrared (NIR) optical properties (Berglund C N and Guggenheim R I, Phys. Rev. 1969, 185, 1022-1033; Goodenough J B. J. Solid State Chem. 1971, 3, 490-500). Due to the relatively low temperature of the metal-to-insulator transition, VO₂ has been investigated for a variety of applications including solid-state memory devices, sensors, and smart-windows. In addition to using direct thermal energy to trigger the transformation, this metal-to-insulator transition phenomenon has also been observed in VO₂ using “all-optical” and “all-electrical” methods.

In 2012, a dramatic metal-to-insulator transition was observed in VO₂ via ionic liquid gating using an electric double layer transistor geometry consisting of a thin film of VO₂ as the channel and an ionic liquid as the gate (Nakano M et al, Nature 2012, 487, 459-462). Application of a gate voltage resulted in a lowering of the metal-to-insulator transition temperature across the channel, with sufficiently high voltages leading to a stabilization of the metallic state across all temperatures. The mechanism behind this induced metallization, however, is the subject of debate. Nakano and coworkers first attributed this change in conductivity to collective bulk carrier delocalization induced by electrostatic charge accumulation at the ionic liquid interface. Nakano's description of the electronic origin of this electrochemical metal-to-insulator transition follows the explanation from Zylbersztejn and Mott that insulating behavior in monoclinic VO₂ is driven by strong electron correlations, rather than purely structural distortions (Zylbersztejn A and Mott N F, Phys. Rev. B 1975, 11, 4383-4395). In a similar configuration in 2013, however, Jeong and co-workers found that ionic liquid gating does more than electronically charge the VO₂ film, reporting that metallization was accompanied by the generation of oxygen vacancies within the material (Jeong J et al. Science 2013, 339, 1402-1405). Subsequent studies by both groups found that VO₂ films undergo significant structural changes during gating, with an anisotropic expansion of 3% oriented along the rutile c-axis, parallel to the direction of V—V dimerization in monoclinic VO₂ and of the open oxygen-diffusing channels along shared edges of VO₆ octahedra (Okuyama D et al. Appl. Phys. Lett. 2014, 104, 023507; Jeong J et al. Proc. Natl. Acad. Sci. 2015, 112, 1013-1018; Passarello D et al. Appl. Phys. Lett. 2015, 107, 201906). The electrochemical metal-to-insulator transition was found to be substrate dependent; epitaxial orientations that aligned the rutile c-axis parallel to the growth substrate impeded c-axis strain or oxygen diffusion, and did not show gating induced structural or electronic changes (Jeong J et al. Science 2013, 339, 1402-1405; Nakano M et al, Adv. Electron. Mater. 2015, 1, 1500093). The expanded metallic phase induced by gating was proposed by Karel et al. to be a distorted oxygen-deficient monoclinic structure showing decreased V—V dimerization and d-band splitting (Karel J et al. ACS Nano 2014, 8, 5784-5789), drawing from Goodenough's description of the thermal metal-to-insulator transition in VO₂ as a structural Peierls-like instability in the V3d band (Goodenough J B. J. Solid State Chem. 1971, 3, 490-500). Recent studies of gated VO₂ films covered with mediating capping layers have provided additional evidence for the role of oxygen vacancy defects in the electrochemical metako-insulator transition. A graphene monolayer grown between VO₂ thin film and gating electrolyte impedes the metal-to-insulator transition by blocking oxygen diffusion out of the lattice (Zhou Y et al. Nano Lett. 2015, 15 (3), 1627-1634), while epitaxial capping layers of rutile TiO₂ that are thick enough to occupy the entire electrostatic screening length still enable gated metal-to-insulator transition through oxygen diffusion out of the VO₂ lattice (Passarello D et al. Nano Lett. 2016, 16(9), 5475-5481). Remarkably, gated optical and electronic switching penetrates to a depth of at least 90 nm in an epitaxial VO₂ film, even though the region of high strain fields (Passarello D et al Appl. Phys. Lett. 2015, 107, 201906), oxygen exchange (Jeong J et al. Science 2013, 339, 1402-1405) and electrostatic screening (Zhou Y et al. Nano Lett. 2015, 15 (3), 1627-1634) only extend about 10 nm into the surface. Orientation and strain accommodation strongly influence the gating process, although the latter is limited by the coherence of the gated film with its underlying substrate.

Nanocrystals (NCs) can accommodate strain better than epitaxial films due to the lack of constrained coherence with neighboring grains or the underlying substrate. A recent study by Sim et al. found enhancement of the ionic liquid gating effect in self-supported VO₂ sub-50 nm thick membranes compared to sputtered films of similar thickness, proposing that the unconstrained VO₂ electrolyte interface simultaneously enables relaxation of tensile stress and minimizes diffusion pathways to the electrolyte (Sim J S et al. Nanoscale 2012, 4, 7056-7062). Nanocrystalline films can accommodate strain and surface diffusion processes through an abundance of electrolyte interfaces. It was therefore hypothesized that electrochemically induced metal-to-insulator transition would be observed in films of VO₂nanocrystals without the limitations imposed by crystalline orientation that are inherent to epitaxial thin films.

Despite the interest in VO₂nanocrystals for their desirable optical properties (Li S Y et al. J. Appl. Phys. 2010, 108, 063525) and potential for size-dependent phase behavior (Lopez R et al. Phys. Rev. B 2002, 65, 224113), their chemical synthesis remains challenging. The complicated phase diagram of the vanadium-oxygen system contains many stable and metastable compounds and phases, thus making stabilization of a particular phase difficult (Wriedt H A. Bulletin of Alloy Phase Diagrams 1989, 10, 271-277). Nevertheless, several routes to nanostructured VO₂ with varying degrees of morphology control have been reported including solvothermal synthesis (Son J H et al, Chem. Mater. 2010, 22, 3043-3050; Whittaker L et al, J. Am. Chem. Soc. 2009, 131, 8884-8894; Sun Y et al. Nanoscale 2011, 3, 4394-4401) and polymer assisted deposition (Kang L et al. ACS Appl. Mater. Interfitces 2011, 3, 135-138). Optical quality films suitable for spectroelectrochemical investigation can be prepared from colloidal nanocrystals (Garcia G et al. Nano Lett. 2011, 11, 4415-4420; Hordes A et al. Nature 2013, 500, 323-326), thus making this approach to VO₂nanocrystals most attractive. Unfortunately, a direct colloidal synthesis of VO₂ nanocrystals has not yet been reported. The conversion of VOₓ colloidal nanocrystals with an unidentified crystal structure into VO₂ films using a rapid thermal annealing process has been reported; however this process sinters the nanocrystals into a non-porous film of larger polycrystalline particles (Paik T et al. ACS Nano 2014, 8, 797-806).

Herein, the development of a low-temperature, oxidative annealing process to convert films of metastable bixbyite V₂O₃ nanocrystals (Bergerud A et al. Chem. Mater. 2013, 25, 3172-3179) to VO₂ while maintaining mesoporous, nanoscale crystalline domains and high optical quality is discussed. Upon electrochemical reduction, these nanocrystal films transform from monoclinic phase to an infrared (IR) blocking, conductive monoclinic state, consistent with the effects of ionic liquid gating on VO₂ thin films. However, upon further reduction, a reversal in this IR darkening was observed, leading to a new IR transparent state that, according to X-ray absorption spectroscopy (XAS) and X-ray diffraction (XRD), is an oxygen-deficient expanded rutile-like phase. Hence, the electrochemical reduction of the VO₂nanocrystal films can instigate a reversible phase transformation that has not been revealed by gating epitaxial thin films with ionic liquid electrolyte.

V₂O₃ colloidal nanocrystals with a metastable bixbyite crystal structure were first synthesized via aminolysis reaction using standard Schlenk line techniques (Bergerud A at al. Chem. Mater. 2013, 25, 3172-3179). Briefly, vanadyl acetylacetonate (1 mmol) (Strem Chemicals, 98%), oleylamine (4 mmol) (Sigma Aldrich, 70%), oleic acid (4 mmol) (Sigma Aldrich, 90%), and squalane (8 mL) (Sigma Aldrich, ≧95%) were mixed and degassed at 110° C. The suspension was then heated under nitrogen flow to 370° C. for 1 hour before cooling, followed by repeated washing with isopropanol and hexanes.

The cleaned V₂O₃ colloidal nanocrystals (˜50 mg/mL) was then deposited onto cleaned ITO coated glass substrates or doped silicon substrates via spin coating or drop casting. Briefly, 20 μL of the nanocrystal ink was added to a 2×2 cm substrate, which was then spun at 1000 rpm for 90 s and dried at 4000 rpm for 30 s. Film thickness was determined to be 83±3 nm using a Veeco Dektak 6M Stylus Profilometer, unless otherwise noted.

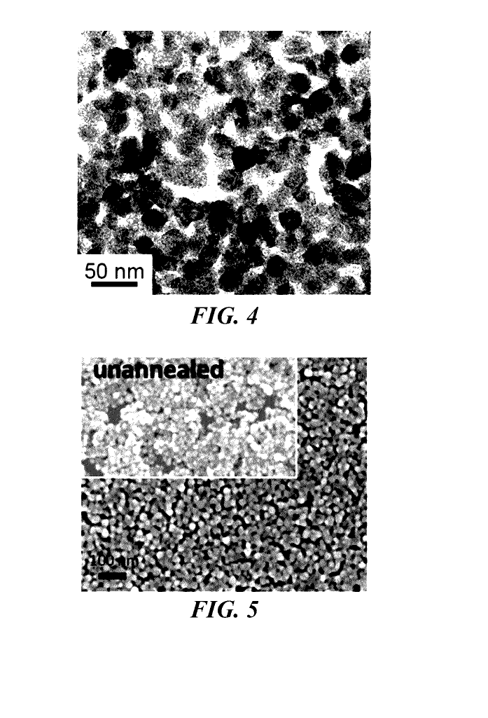

The as-deposited bixbyite V₂O₃ nanocrystal film was then converted to monoclinic VO₂ by a mild annealing treatment in a slightly oxidative environment (e.g., low oxygen partial pressure). The films were annealed in 167-250 ppm O₂ atmosphere for 30-60 minutes. The atmosphere also included an inert gas, such as N₂. The size of the VO₂ grains was controlled between about 20 nm and 50 nm diameter by varying the temperature of the annealing process. All films were annealed at 375° C. unless otherwise noted. Optical photographs of the films before and after conversion are shown in FIG. 2. Transmission electron microscopy (TEM) and scanning electron microscopy (SEM) were used to observe the morphology of the nanocrystals before (FIG. 3) and after conversion (FIG. 4, FIG. 5).

Transmission electron microscopy (TEM) micrographs were collected using a JEOL 2010F TEM with a Schottky field emission source operating at 200 kV. A sample was prepared by drop casting a dilute suspension on V₂O₃ nanocrystals in hexanes on a silicon nitride TEM grid. The TEM grid was annealed under the same conditions as films (375° C., 1 hr, 250 ppm O₂) to convert to VO₂ nanocrystals. Scanning electron microscopy (SEM) micrographs were collected using a Hitachi S5500 scanning electron microscope operating at 20 kV accelerating voltage. The samples were prepared by drop casting films of V₂O₃ nanocrystals in hexanes on a silicon wafer and annealing them under the same conditions as used for equivalent VO₂ films.

The as prepared V₂O₃ nanocrystals are well separated with an average diameter of approximately 25 nm (FIG. 3). During the oxidative transformation, diffusion leads to necking between the nanocrystals, resulting in a porous nanocrystal network (FIG. 4).

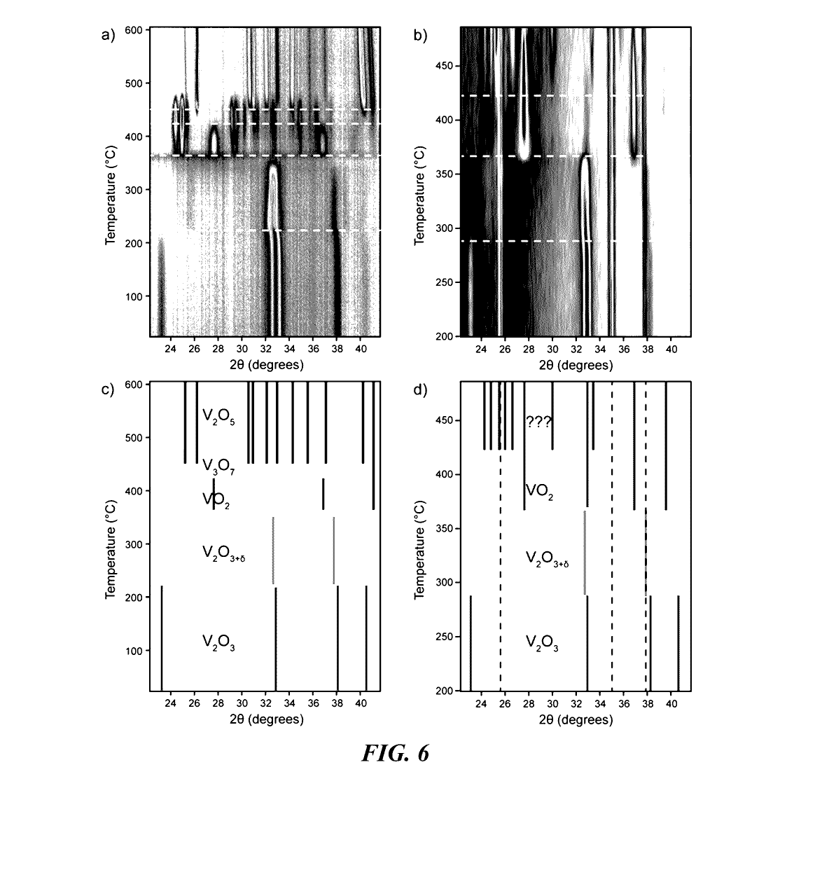

FIG. 6 shows the in-situ X-ray diffraction (XRD) of V₂O₃ nanocrystals annealed in air (panel a and panel c) and in 250 ppm O₂ in N₂ (panel b and panel d).

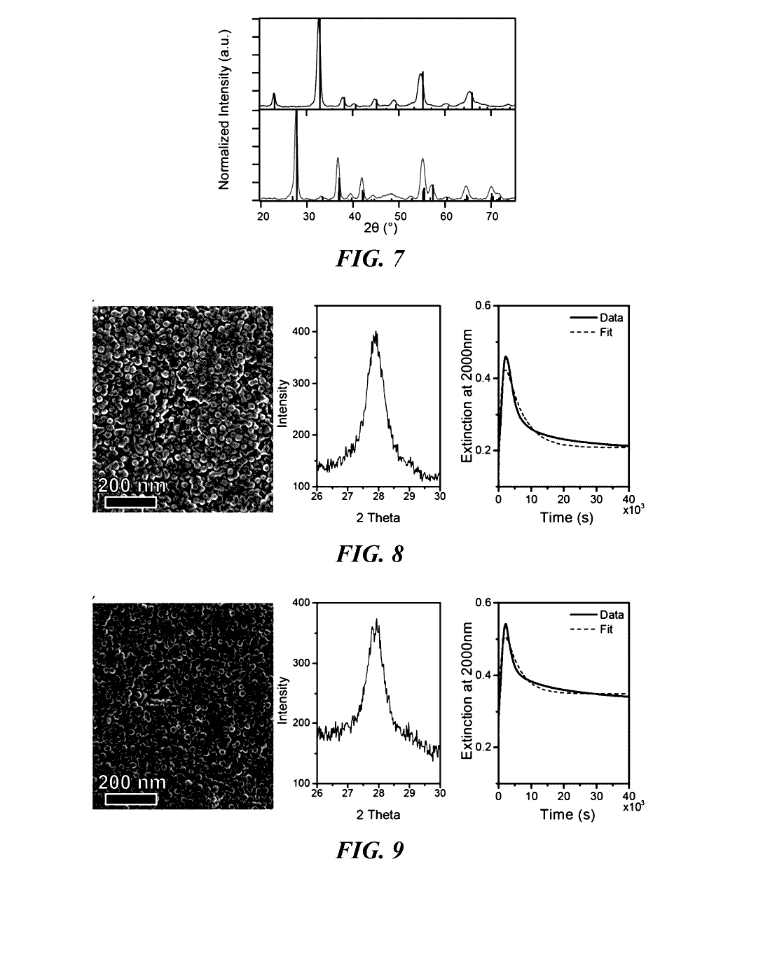

The crystal structure before and after conversion was determined via X-ray diffraction (XRD), and indexed to the bixbyite V₂O₃ and monoclinic VO₂ structures, respectively (FIG. 7). X-ray diffraction (XRD) for the V₂O₃ to VO₂ conversion characterization was performed using a Rigaku R-axis Spider diffractometer with an image plate detector and Cu Kα radiation. Films were prepared on silicon substrates and data was collected in reflection mode over 10 minutes of exposure. X-ray diffraction for Scherrer analysis of crystallite grain size was measured using a Rigaku Miniflex 600 diffractometer with a Cu Kα X-ray source operating at 40 kV and 15 mA, with a graphite monochromator. Multiple scans were collected between 2θ=26° and 30° with a step size of 0.02° and scan speed of 1°/min.

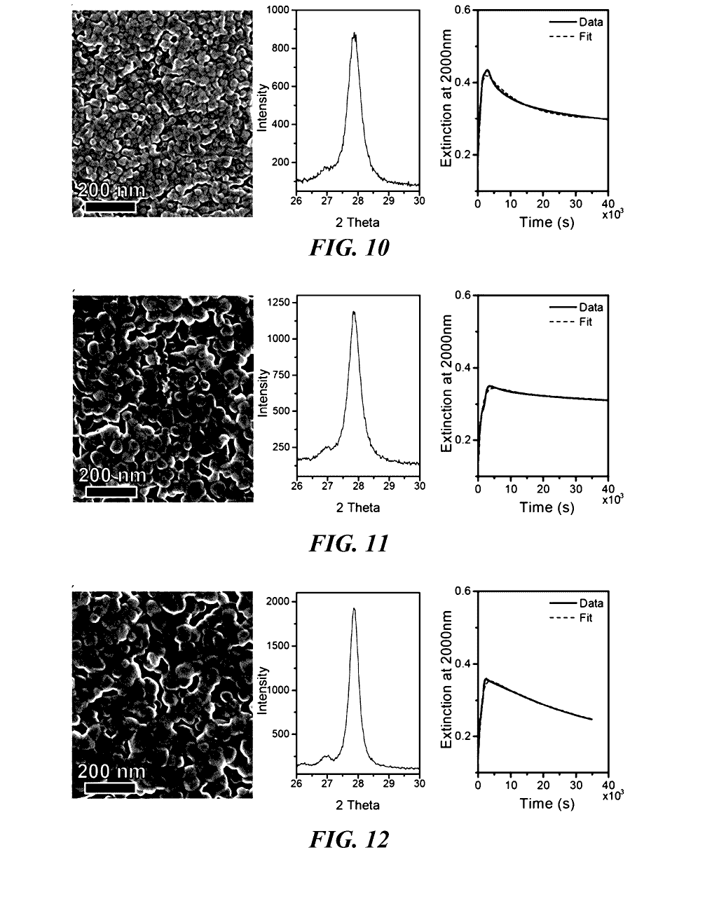

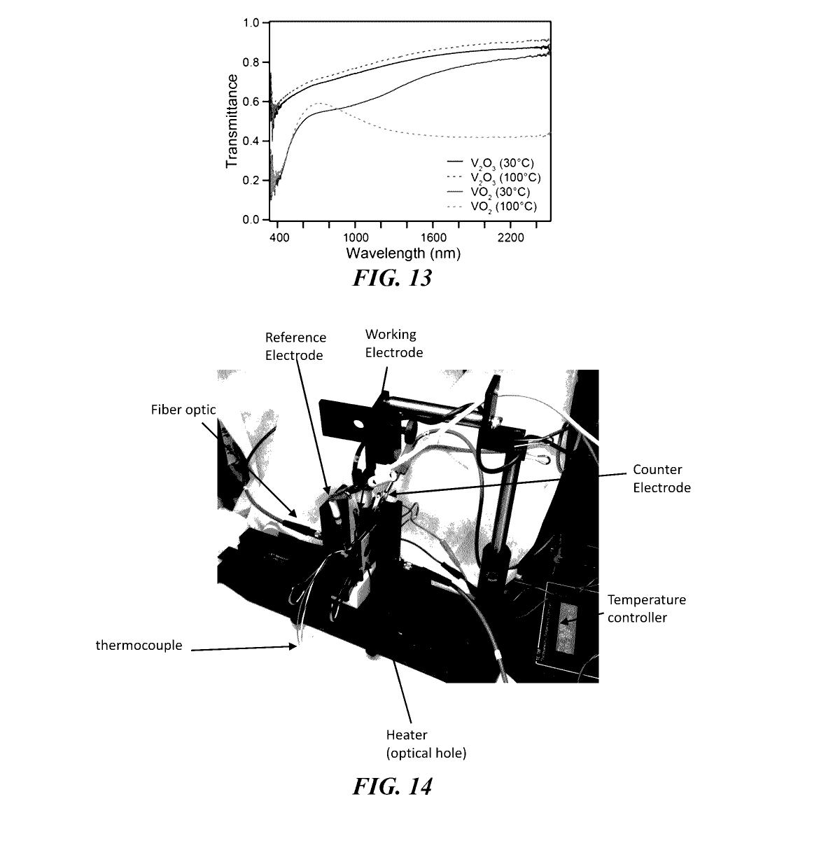

A decrease in X-ray diffraction peak widths between bixbyite and monoclinic suggests that a small degree of coarsening occurs upon conversion (FIG. 7). This coarsening is dependent on annealing temperature, with higher temperatures yielding larger VO₂ crystallites as determined by Scherrer analysis referenced against a LaB6 standard (FIG. 8-FIG. 12). The resulting VO₂ nanocrystals are thermochromic, exhibiting diminished IR transmittance at elevated temperature (FIG. 13), consistent with the expected metal-to-insulator transition phase transformation from monoclinic to ruffle phase.

To investigate the response of the VO₂ nanocrystals to electrothemical biasing, in situ variable temperature spectroelectrochemistry (VT-SEC) was performed. Electrochemical analysis of the VO₂ films was performed using a Bio Logic VMP3 Potentiostat The VO₂ film was set as the working electrode, platinum foil as the counter electrode, and frilled Ag/Ag⁺ cell as the reference electrode. The Ag/Ag⁺ electrode was calibrated against a Li/Li⁺ electrode and was found to be −3.00 V vs Li/Li⁺ Vollages herein are reported relative to a normal hydrogen electrode (NHE). The three-electrodes were housed in a custom built cell that enabled a minimal pathlength through the electrochemical mediator comprising 0.1 M tetrabutylammonium bis-trifluoromethanesulfonimidate (TBA-TFSI) (Sigma Aldrich, ≧99.0%) in propylene carbonate (Sigma Aldrich, 99.7%). Spectroscopy (400-2200 nm) was performed with an ASD Inc. PANalytical spectrometer operating in transmission mode, which was directed through the VO₂ film using fiber optic cables. The temperature was controlled using a TC-720 temperature controller with a Peltier thermoelectric element with a center hole (TE Technologies) to allow a continuous optical path through the system. The temperature was monitored with an epoxy bead thermistor (TE Technologies). For the experiments described herein, the entire variable temperature spectroelectrochemistry set-up was housed in an inert atmosphere (e.g., argon) glove box maintained at <1 ppm O₂ (FIG. 14).

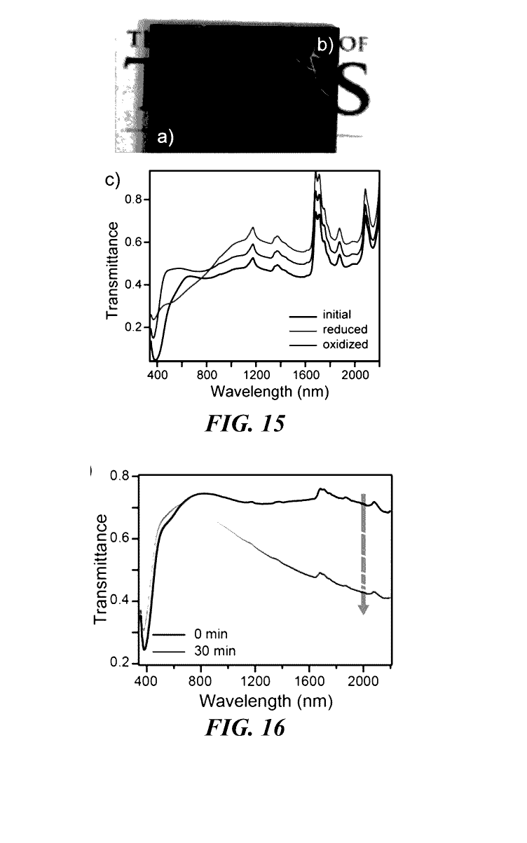

The variable temperature spectroelectrochemistry (VT-SEC) system enabled collection of vis-NIR transmission spectra of the CO₂ nanocrystal film in situ using a fiber-coupled spectrometer (FIG. 15) such that the response of the VO₂ nanocrystals to electrochemical biasing could be investigated. Irreversible optical changes were observed when lithium-containing electrolyte was used, likely due to the intercalation of Li⁺ ions in the VO₂ lattice resulting in an irreversible phase transformation (FIG. 15), consistent with the results of Kahn et al on thin films (Khan M S R et al. J. Appl. Phys. 1991, 69, 3231-3234). When lithium was replaced with a bulky counter-ion, specifically tetrabutylammonium (TBA⁺), intercalation was inhibited and reversible optical modulation was observed.

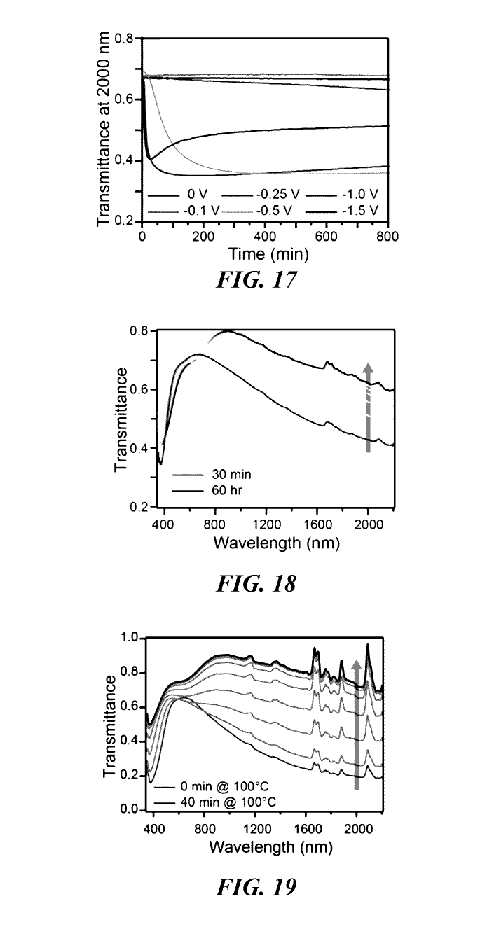

The spectroelectrochemistry results of VO₂ nanocrystal films on ITO-coated glass in 0.1 M TBA-TFSI electrolyte are shown in FIG. 16-FIG. 19. Upon application of a reducing bias (−1.5 V vs NHE) at room temperature, a strong decrease in near-infrared (NIR) transmittance was observed for the VO₂nanocrystal film (FIG. 16). This spectroscopic observation is in agreement with the previous report of metallization in ionic liquid gated epitaxial VO₂ films (Nakano M et al. Appl. Phys. Lett. 2013, 103, 153503). These results demonstrate that optoelectronic modulation is possible in the VO₂nanocrystals even without ionic liquids, which are known to deliver the highest local fields. Furthermore, darkening of the VO₂nanocrystal film was found to occur at very low applied potentials, albeit at a slower rate (FIG. 17). Continued application of a reducing bias beyond the initial darkening, however, eventually lead to an unexpected reversal of the IR darkening (FIG. 18). The bleaching effect is much slower than the IR darkening, and was only observable after long charging times at moderate reducing potentials. Voltage-induced IR bleaching was also observed upon reduction of the ruffle phase of VO₂ at 100° C. but at a much faster rate (FIG. 19). The more rapid bleaching of hot rutile VO₂ may be due to faster kinetics of oxygen diffusion, metallic conductivity, or increased electrochemical reactivity (Singh S et al. Phys. Rev. B 2016, 93, 125132) in rutile VO₂.

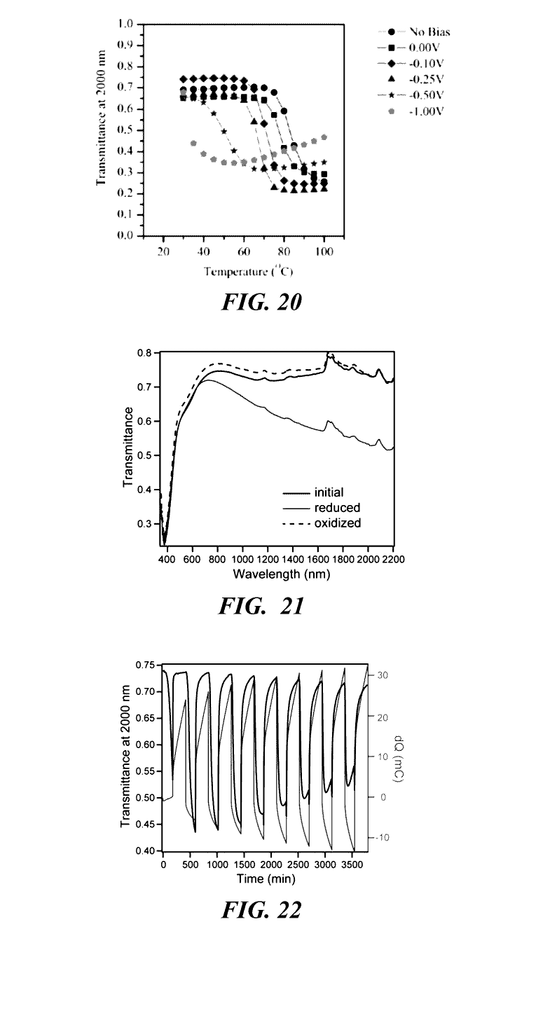

A comparison of temperature (x-axis) vs. transmittance of near infrared light (at a wavelength of 2000 nm) (y-axis) for nanocrystalline VO₂ with no electrochemical bias and under applied biases between 0 and −1 V vs. NHE is shown in FIG. 20.

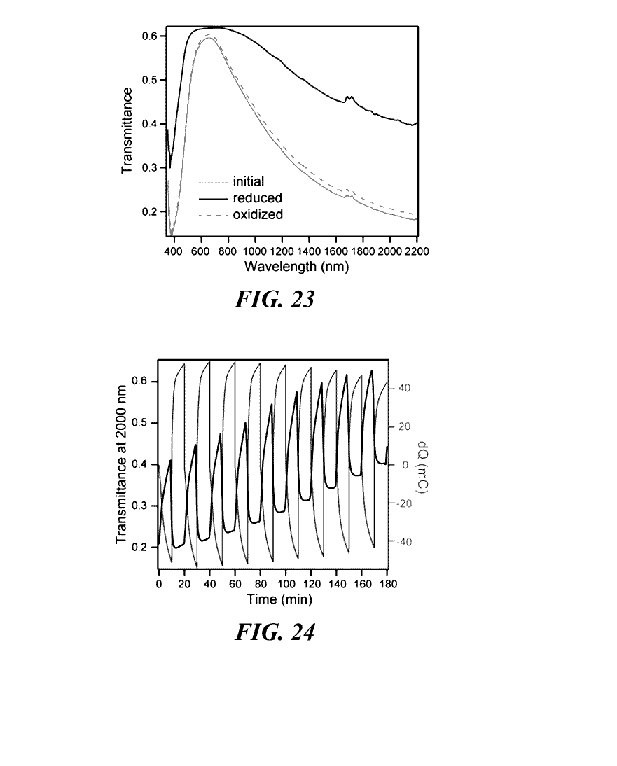

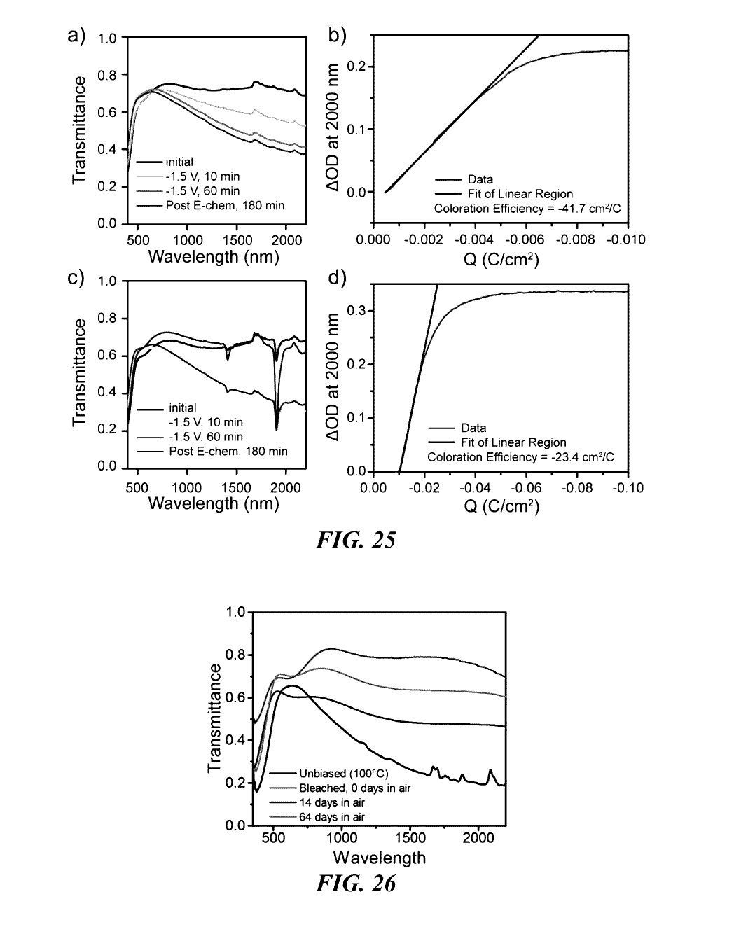

Darkening and bleaching were found to be reversible upon the application of an oxidizing potential (FIG. 21, FIG. 22, FIG. 23, and FIG. 24). Variable temperature spectroelectrochemistry experiments were also performed in air using a similar set-up in an air environment by moving the entire spectroelectrochemistry set-up outside the glovebox and bubbling the electrolyte with air for 2 hours. These experiments found that electrochemical modulation of IR transmittance was possible even in an oxygen-rich environment, albeit with lower coloration efficiency than in an inert environment (FIG. 25), an effect not observed in previous ionic liquid gated epitaxial films despite the higher achievable local fields (Jeong J et al. Science 2013, 339, 1402-1405).

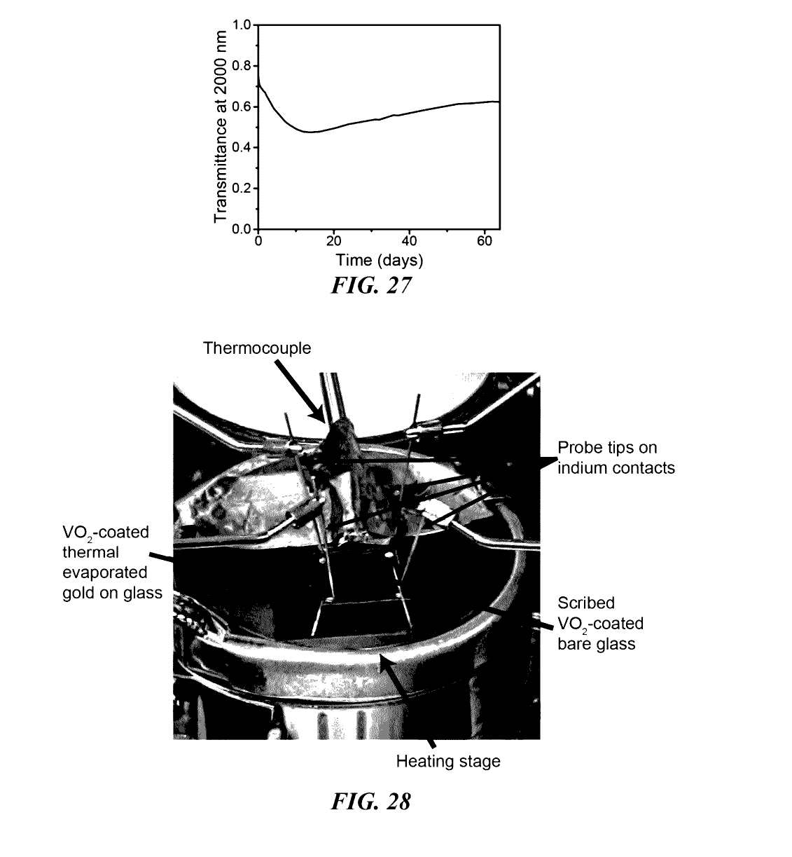

While electrochromism was observed for films in both argon and air environments, after removing the electrochemical bias the NIR transmission of both darkened and bleached films slowly to an optical state characteristic of the original monoclinic structure in the air environment, while films in argon remained unchanged (FIG. 26 and FIG. 27). In fact, as long as the film was not exposed to oxygen, could the electrode could be removed and rinsed with no effect to the optical state, suggesting that the VO₂ material is transformed under applied potential, not merely gated electrostatically. This observation was attributed to the oxidation of the reduced state in the presence of oxygen. This oxidation process is further supported by the increase in charge by an order of magnitude but lower coloration efficiency for the air environment as the oxygen is continuously oxidizing the film during the reduction process, consuming a large part of the injected charge.

To correlate the observed optical Changes with electronic properties, the temperature dependent electrical resistivity of unbiased and charged VO₂ films was obtained by using the Van Der Pauw four point probe measurement geometry. Films were prepared by spin coating V₂O₃ nanocrystals on high-resistivity glass substrates with a thin 30 inn layer of gold deposited as an electrode contact in an L-shaped area on the substrate. A 1 cm² bare glass region was retained in the corner of the film to allow for four point probe conductivity measurements after electrochemical charging. The spin-coated V₂O₃ nanocrystal film was annealed under the same conditions to produce VO₂ nanocrystals for spectroelectrochemical measurements described previously. After biasing, the VO₂ film was rinsed and dried, and the outside of the bare glass region was electrically isolated from the gold-coated region using a diamond scribe. Indium metal was pressed into each of the four corners of the bare glass region as metal contacts for VO₂ film, and the film was transferred air-free to a N₂ glovebox containing the temperature-dependent four point probe measurement apparatus (FIG. 28). Measurements were made air-free with four-point probe in the Van der Pauw geometry to avoid oxidation of the material. All measurements were taken with a probe current of 10 μA, which was found to be within the Ohmic region. All samples were measured for resistivity across a temperature range of 30° C. to 100° C. and back in 5° C. intervals to test for thermal effects.

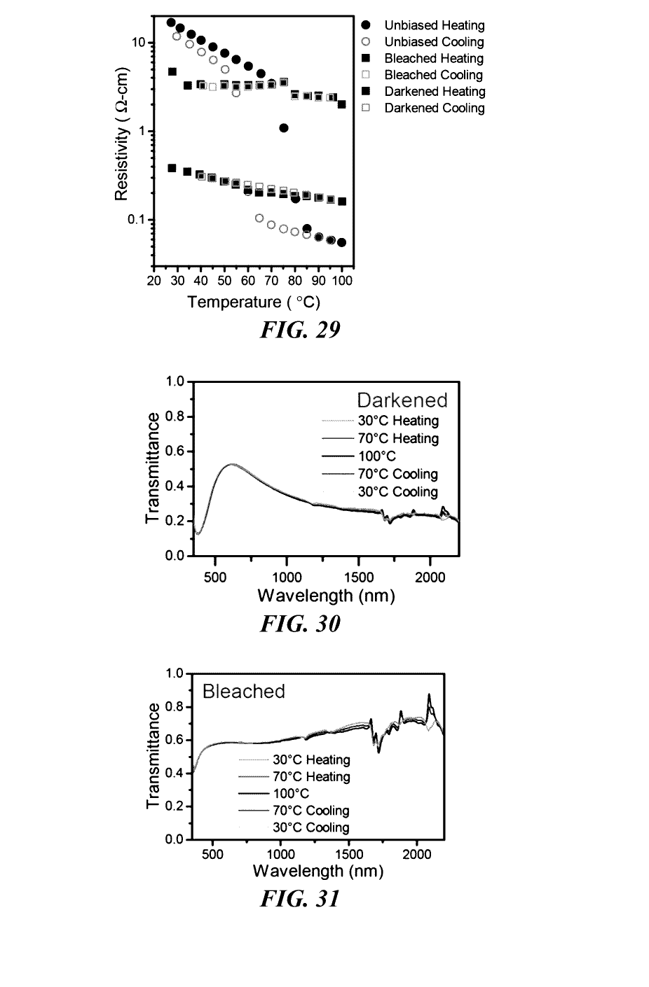

The Van der Pauw measurements of the unbiased films show the characteristic metal-to-insulator transition of VO₂ around 68° C., and a hysteresis of about 20° C. between heating and cooling curves (FIG. 29). The resistivity in these films is much higher than would be expected for bulk (Berglund C N and Guggenheim H J. Phys. Rev. 1969, 185, 1022-1033) or thin-film (Nakano M et al. Nature 2012, 487, 459-462) VO₂ due to film mesoporosity. Nonetheless, the resistivity of unbiased films changes by two orders of magnitude across the thermal metal-to-insulator transition (FIG. 29). Electrochemical biasing shows similar switching, inducing lowered resistivity in the IR darkened state and an order of magnitude higher resistivity in the IR bleached state (FIG. 29). The spectroelectochemical observations are thus attributed to a sequential insulator-metal-insulator transition. Furthermore, both the bleached and darkened states retain their resistivity and optical transmittance across the entire tested range of temperatures, demonstrating that the thermal metal-to-insulator transition is suppressed upon biasing (FIG. 29, FIG. 30, and FIG. 31).

To understand the structural changes occurring wit' progressive reduction, X-ray diffraction (XRD), X-ray absorption spectroscopy (XAS), and Raman spectroscopy were performed on nanocrystal films in various optical states, including the initial monoclinic, thermally darkened (ruffle), electrochemically darkening, and partly or fully electrochemically bleached states. Films were prepared on doped silicon for use across a range of analytical techniques. As the kinetics of darkening and subsequent bleaching, in the I R are sensitive to applied bias (FIG. 17) and temperature (FIG. 18 and FIG. 19) these states were accessed using different time-potential-temperature trajectories; a variety of preparations were studied to avoid ambiguity and ensure that a complete set of samples in different optical states was obtained for analysis. The darkening state was prepared with a small applied bias to avoid overshoot into the bleached state, while the darkened state was prepared to access the maximum decrease in IR transmittance. The partially bleached sample was accessed by applying a high, heated bleaching bias for half the time required to achieve complete IR bleaching. Table 1 describes the complete list of sample preparations.

TABLE 1
Summary of the variety of sample preparations described herein.

| Sample Name | Temperature | | Bias Voltage vs NHE | | Bias Time | |
|---|---|---|---|---|---|---|
| Monoclinic (R.T.) | 25° | C. | unbiased | | N.A. | |
| Rutile (100° C.) | 100° | C. | unbiased | | N.A. | |
| Darkening | 25° | C. | −0.5 | V | 7.5 | hrs |
| Darkened | 25° | C. | −0.5 | V | 17 | hrs |
| Bleaching | 25° | C. | −2 | V | 30 | min |
| Partially Bleached | 100° | C. | −1.5 | V | 5-20 | min |
| Bleached | 100° | C. | −1.5 | V | 10-40 | min |

Raman spectroscopy was performed on a Horiba Jobin Yvon LabRAM ARAMIS spectrometer using a 532 nm laser. Electrochemistry of the VO₂ films on doped silicon substrates was performed in a glovebox before transfer to the Raman instrument using a Linkam LTS420 cell. The Linkam cell not only prevented rapid oxygen contamination, but also enabled analysis at temperatures above and below the metal-to-insulator transition temperature. Measurements were taken under a 50× long working distance microscope objective.

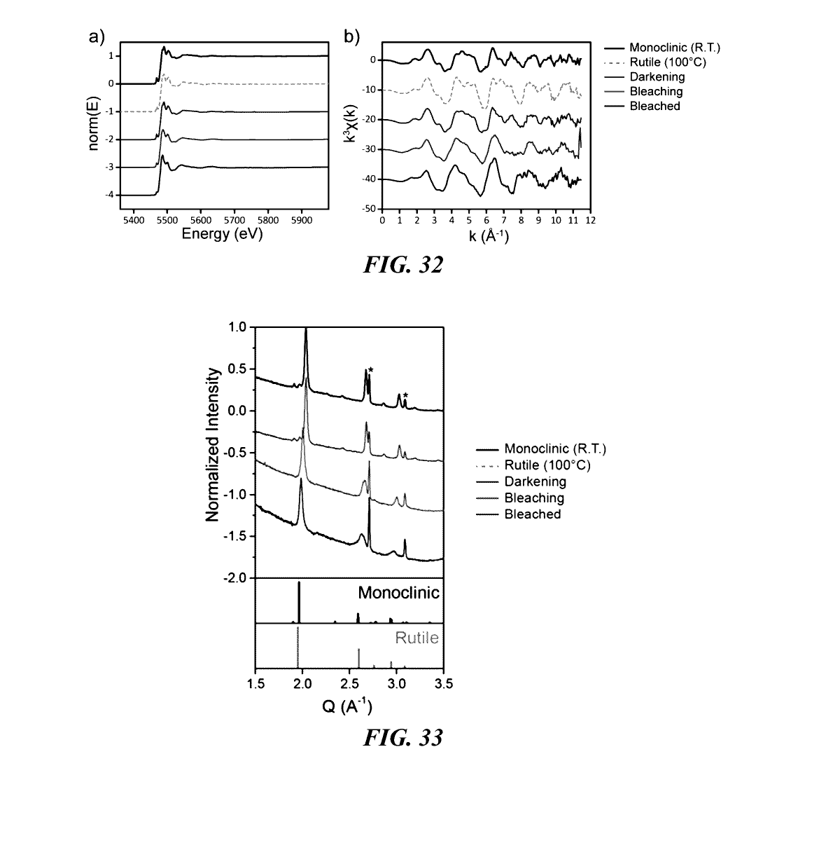

X-Ray Absorption Spectroscopy (XAS) spectra were collected at beamline 10.3.2 of the Advanced Light Source. Vanadium K-edge spectra were collected in fluorescence mode using an Amptek silicon drift fluorescence detector 1-element (XR-100SDD) collected at ambient temperature (25° C.) for all spectra except the rutile sample, which was heated to 100° C. in air using a Peltier heating element affixed to the back of the sample substrate during measurements. The darkening, bleaching, and bleached films were electrochemically reduced then sealed with a mylar film in an argon glovebox before X-ray absorption spectroscopy measurement to prevent air exposure. A Si (111) monochromator was used with a resolving power (ΔE/E) of 7000 at 10 keV. More details about the beamline can be found elsewhere (Marcus M A et al. J. Synchrotron Rad. 2004, 11, 239-247). V K-edge extended X-ray absorption fine structure (EXARS) were collected in the energy range of 5360 to 5980 eV. Each X-ray absorption spectrum was averaged from two consecutive scans, each about 45 minutes long. The experimental data was energy calibrated to a vanadium foil measured in transmission mode. Preliminary analysis to scan average and background the pre- and post-edge features was performed using software developed at ALS beamline 10.3.2, and normalization and post-processing of μ(E) data was performed using Athena and Artemis from the Demeter package (version 0.9.24) (Ravel B et al. J. Synchrotron Rad., 2005, 12, 537-541). Extended X-ray absorption fine structure (EXAFS) Fourier transforms were converted into real space with a Hanning window in the k-space range of 2.6-10.6 Å-1. Complete X-ray absorption spectroscopy and k-space extended X-ray absorption fine structure data is presented in FIG. 32.

To assess the crystal structure of the nanocrystal film in different optical states, ex situ Grazing-Incidence Wide Angle X-ray Scattering (GIWAXS) on biased films in an air-free helium enclosure (0.1% O₂) was utilized. Grazing-incidence wide-angle X-Ray scattering measurements were taken at beamline 7.3.3 of the Lawrence Berkeley National Laboratory Advanced Light Source, using a 10 keV synchrotron X-ray source. All measurements were collected at an incidence angle of 0.10 degrees. Silver behenate was used as a standard. The measurements reported herein are radial sector averages between 4 degrees on either side of vertical (parallel to the beam and normal to the substrate) of the intensity measurements collected on a 2D detector roughly 30 cm from the sample. Data processing, to convert from collected 2D images to 1D data, was performed using the Nika software suite (Ilaysky J. J. Appl. Cryst. 2012, 45, 324-328). The sector average was limited to a narrow slice to avoid averaging across distortions in Q-values caused by the grazing incidence geometry. Typically, grazing-incidence wide angle X-ray scattering measurements collected by a 2D detector are treated qualitatively because of geometric distortions in the isotropic Q values (Baker et al. Langmuir 2010, 26 (11), 9146-9151). Accounting for the grazing incidence geometry is expected to introduce a non-linear shift in q-values, but the small incidence angle (0.10 degrees) and limited range of 2D averaging should make this effect quite minor, as expected from a comparison of the diffraction patterns of the monoclinic VO₂ films between wide angle X-ray scattering (WAXS) data in FIG. 7 and grazing-incidence wide angle X-ray scattering data in FIG. 33.

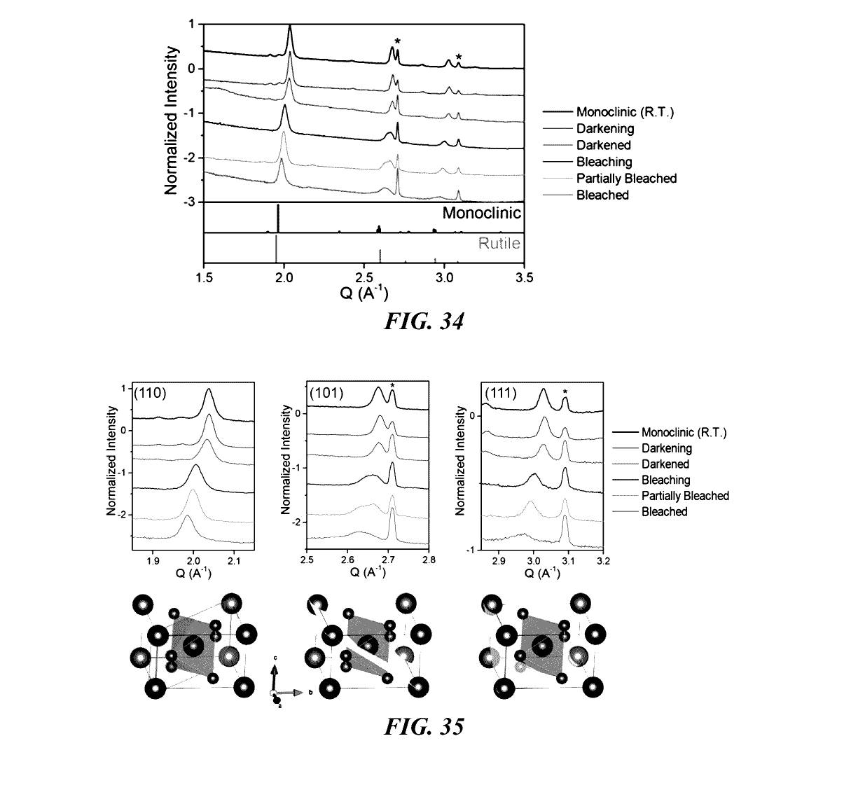

The grazing-incidence wide angle X-ray scattering on the unbiased films show peaks characteristic of monoclinic VO₂, albeit with a slight distortion to larger Q values due to the grazing incidence geometry (FIG. 33). The darkening film retains the monoclinic structure with minimal distortion (FIG. 33). However, further reduction shows a progressive increase in the lattice constants from the bleaching to the fully bleached states FIG. 34 and FIG. 35). This is accompanied by a widening of the peaks, likely due to increased inhomogeneous strain, and disappearance of the smaller monoclinic peaks. The bleached state can be indexed to an expanded rutile lattice, although the broadened peaks may hide possible minor features indicative of structural distortions.

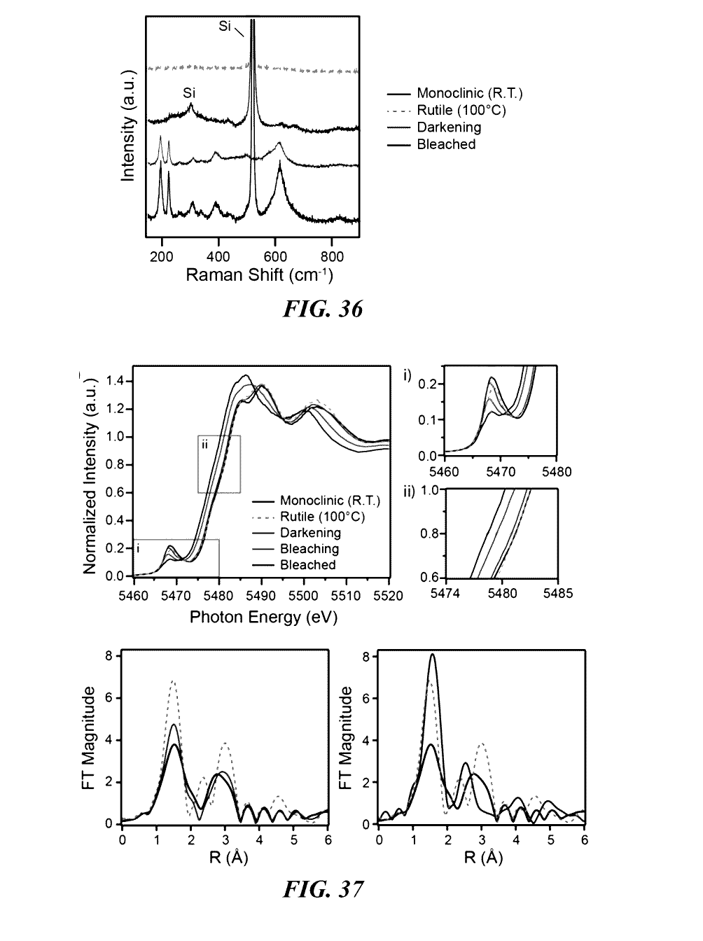

Raman spectroscopy also supports a structural transformation from a monoclinic structure in the unbiased and darkened films to a more symmetric rutile-like structure upon bleaching (FIG. 36). At low temperature for the unbiased VO₂ peaks indicative of the monoclinic (M1) phase are apparent due to asymmetric V—O bonding in the V—V dimerized unit cell (FIG. 36). As the film is heated, VO₂ transforms to the more symmetric rutile phase and these peaks decrease in intensity and eventually disappear (FIG. 36), consistent with previous Raman studies on VO₂ nanostructures (Zhang S et al. Nano Lett. 2009, 9, 4527-4532; Jones A C et al. Nano Lett. 2010, 10, 1574-15; Whittaker L et al. ACS Nano 2011, 5, 8861-8867). Ex situ air-free Raman spectra of-the darkening state contains peaks that index to the monoclinic phase (FIG. 36). This is in agreement with Jeong and co-workers finding that V—V dimerization, an identifying feature of the monoclinic phase, is maintained upon electrochemical metallization and is also consistent with recent Raman studies on ionic liquid gated VO₂ thin films Jeong J et al. Proc. Natl. Acad. Sci. 2015, 112, 1013-1018; Singh S et al. Phys. Rev. B 2016, 93, 125132; Chen S et al. Adv. Funct. Mater. 2016, 26, 3532-3541). On the other hand, the bleached state has no obvious Raman peaks, besides those which index to the underlying silicon substrate (FIG. 36). This absence of peaks is consistent with grazing-incidence wide angle X-ray scattering data (FIG. 33) suggesting an increase in structural symmetry and conversion from the monoclinic phase to a more tetragonal rutile-like phase in the bleached state.

The measured d-spacing for each of the primary pseudo-rutile peaks, determined by fitting Voigt peaks to grazing-incidence wide angle X-ray scattering patterns are shown in Table 2. The tetragonal lattice parameters in Table 2 were calculated using the geometric equations for a tetragonal structure:

$$Tetragonal geometry \text{:} a = \sqrt{2} {d}_{110} ; c = \frac{{ad}_{101}}{\sqrt{{a}^{2} - {d}_{101}^{2}}} = \frac{{ad}_{111}}{\sqrt{{a}^{2} - 2 {d}_{111}^{2}}}$$

A tetragonal structure was used as a simple model to compare expansion in different lattice directions, even though the samples may have monoclinic distortions. The discrepancy between calculated c parameters from the measured (101) and (111) peaks may be due to distortions from the tetragonal structure or grazing-incidence geometry distortions in measured Q values.

TABLE 2
Measured d-spacing for each of the primary pseudo-rutile
peaks and calculated tetragonal lattice parameters.

| | (110) | | (101) | | (111) | |
|---|---|---|---|---|---|---|
| | d-spacing | a param. | d-spacing | c param. | d-spacing | c param. |
| Sample | (Å) | (Å) | (Å) | (Å) | (Å) | (Å) |
| Unbiased R.T. | 3.08 | 4.36 | 2.35 | 2.79 | 2.07 | 2.81 |
| Darkening | 3.08 | 4.36 | 2.34 | 2.78 | 2.07 | 2.80 |
| Darkened | 3.09 | 4.37 | 2.35 | 2.78 | 2.08 | 2.80 |
| Bleaching | 3.13 | 4.43 | 2.36 | 2.79 | 2.09 | 2.82 |
| Partially | 3.14 | 4.44 | 2.37 | 2.80 | 2.10 | 2.82 |
| Bleached | | | | | | |
| Bleached | 3.16 | 4.47 | 2.39 | 2.82 | 2.12 | 2.85 |

Unlike earlier studies of gated epitaxial VO₂, which found a 3-5% out-of-plane expansion in the rutile c-axis, very little expansion upon darkening was found herein. Instead, lattice expansion happens mostly during bleaching, with the fully bleached state experiencing isotropic lattice expansion of roughly 2% along all three rutile axes (Table 2), or about 7% volume expansion. These results suggest that the nanocrystal morphology allows relaxation with minimal constraint, unlike epitaxial VO₂ films in which lattice expansion is restricted to the rutile c-axis (Okuyama D et al. Appl. Phys. Lett. 2014, 104, 023507; Jeong J et al. Proc. Natl. Acad. Sci. 2015, 112, 1013-1018; Passarello D et al. Appl. Phys. Lett. 2015, 107, 201906; Nakano M et al. Adv. Electron. Mater. 2015, 1, 1500093).

X-ray absorption near-edge spectroscopy (XANES) at the vanadium K-edge was used to characterize the electronic structure of biased VO₂ nanocrystals. A progressive shift in absorption edge indicative of a reduction in the vanadium oxidation state was observed in the near-edge region of the spectra (FIG. 37), implying that inserted charge localizes on vanadium cations. The results of V—K edge X-ray absorption spectroscopy measurements showing the maximum first derivative of the V K-edge and calculated vanadium oxidation state (formal valency) according to the linear relationship between edge shift from monoclinic VO₂ and oxidation state described by Wong et al (Wong J et al. Phys. Rev. B 1984, 30, 5596-5610) are shown in Table 3. The linear function used was: (V Oxidation State)=0.393*(Edge shift from monoclinic 1st derive. Max)+4. A shift in absorption edge, and formal oxidation state, is apparent from monoclinic VO₂ (+4.0) to the darkened state (+3.9), and is more dramatically reduced in the bleached state (+3.3) (Table 3). In the absence of other compensating species such as hydrogen or metallic dopants, this oxidation state change is consistent with compensation of oxygen vacancies upon electrochemical reduction. The pre-edge feature at approximately 5470 eV, attributed to a transition from the V1s to V3d electronic states, was also observed to decrease in intensity with increasing reduction (FIG. 37). This transition is symmetry forbidden, and its suppression in the X-ray absorption near-edge spectra suggests either more d-like character of the V3d orbitals, which is consistent with an increase in octahedral symmetry, or state filling of the V3d bands upon bleaching (Chen J L et al. Pkys. Chem. Chem. Phys. 2015, 17, 3482-3489; Wong J et al. Phys. Rev. B 1984, 30, 5596-5610).

TABLE 3
Results of V-K edge X-ray absorption spectroscopy measurements
showing the maximum first derivative of the V K-edge and
calculated vanadium oxidation state (formal valency).

| | 1st Derivative | V Oxidation |
|---|---|---|
| Sample | Max. (eV) | State |
| Monoclinic in air | 5482.34 | 4.00 |
| (25° C.) | | |
| Rutile in air | 5482.64 | 4.12 |
| (100° C.) | | |
| Darkening | 5482.02 | 3.87 |
| Bleaching | 5481.13 | 3.52 |
| Bleached | 5480.62 | 3.32 |

Grazing-Incidence Wide Angle X-ray Scattering measurements suggest a transformation to a new crystalline phase upon electrochemical bleaching, but the technique can only resolve the long-range order within crystalline domains. Therefore, the extended X-ray absorption fine structure (EXAFS) at the vanadium K-edge was studied to determine the local bonding environment surrounding vanadium (FIG. 32). The darkening and monoclinic patterns are nearly identical, confirming that the darkening state indeed remains in the monoclinic phase even as it becomes metallic through electrochemical reduction (FIG. 32). In contrast to the grazing-incidence wide angle X-ray scattering results, however, the extended X-ray absorption fine structure pattern of the fully bleached state does not match the pattern expected for a simple expansion of the rutile phase (FIG. 32). The bleached state shows a narrowed, large amplitude first bonding shell peak at 1.5 Å (FIG. 32), similar to rutile, which indicates that bleaching recovers local VO₆ octahedral symmetry from the distorted monoclinic or darkening states (Chen J L et al. Phys. Chem. Chem. Phys. 2015, 17, 3482-3489). This amplitude change is accompanied by a slight increase in the nearest-neighbor V—O bond peak distance as well as distortions in other features across the extended X-ray absorption fine structure oscillations (FIG. 32), suggesting an expanded, unique phase with high local octahedral symmetry.

Observation of the bleached phase indicates a sequential insulator-metal-insulator transition in VO₂ upon biasing, but the mechanism of this transformation remains unclear. To elucidate the influence of nanocrystal morphology on the observed darkening and bleaching processes the insulator-metal-insulator transition was induced in VO₂nanocrystal films with different crystallite sizes (FIG. 8-FIG. 12). Sequential darkening and bleaching was modeled as a two-time exponential process, and the time evolution of extinction at 2000 nm with an applied bias was fitted to extract kinetic parameters for different films, according to:

$${Extinction}_{ 2000 nm} ( t ) = - {a}_{dark} exp ( - \frac{t}{{τ}_{dark}} ) + {a}_{bleach} exp ( - \frac{t}{{τ}_{bleach}} ) + {a}_{offset}$$

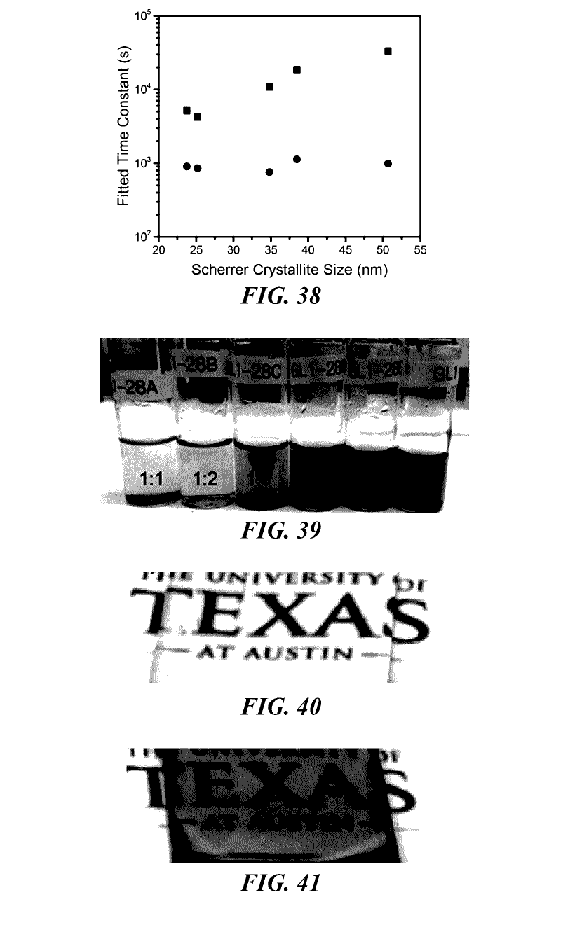

The extracted kinetic parameters for different films are shown in Table 4, including exponential time constants for the darkening and bleaching transformations (FIG. 38). The kinetics of the initial darkening process in the nanocrystal films is not obviously size dependent, however the fitted time constant for bleaching increases by an order of magnitude as crystallite size increases from 23 nm to 50 nm.

TABLE 4
Fitted parameters for the two-exponential model of extinction
at 2000 nm vs. time upon darkening and bleaching.

| Crystallite Size | a_{dark} | a_{bleach} | a_{offset} | τ_{dark} (s) | τ_{bleach} (s) |
|---|---|---|---|---|---|
| 23.8 nm | 0.481 | 0.395 | 0.208 | 901 | 5150 |
| 25.2 nm | 0.439 | 0.319 | 0.349 | 854 | 4190 |
| 34.8 nm | 0.307 | 0.171 | 0.295 | 755 | 10757 |
| 38.5 nm | 0.226 | 0.057 | 0.304 | 1124 | 18638 |
| 50.7 nm | 0.255 | 0.205 | 0.176 | 981 | 33044 |

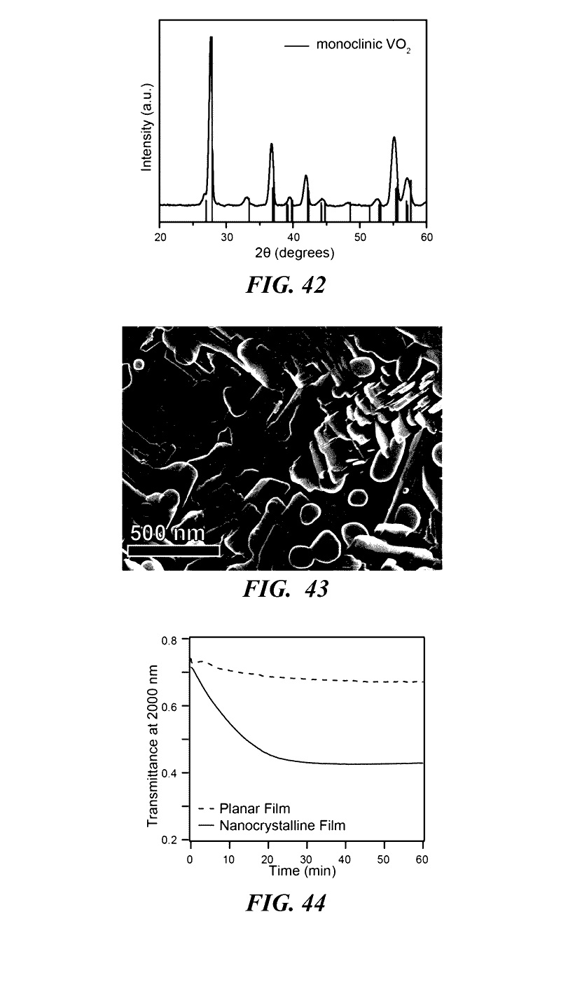

For comparison, microcrystalline planar films with significantly larger grains were prepared via the thermal condensation of vanadium oxalate clusters as previously described in the literature (Llordes A et al. J. Mater. Chem. 2011, 21, 11631-11638). Briefly, ammonium metavanadate (0.5 mmol) (Sigma Aldrich, 99%) was dissolved in 12.5 mL of a 0.2 M oxalic acid solution (1:5 molar ratio) (Sigma Aldrich, 98%) and diluted to a total volume of 15.0 mL. Changing the volume of the oxalic solution added resulted in different vanadium oxide clusters (FIG. 39). After stirring for 72 hours, the blue solution was concentrated to ˜2 mL using nitrogen gas flow. Excess oxalic acid crashed out of the solution and was removed by filtration. The remaining solution was dried completely and a 75 mg/mL solution was prepared in a 90% ethanol, 10% water solution. The solution was then spin coated onto cleaned ITO or silicon substrates at 3000 rpm for 60 s followed by a drying spin at 4000 rpm for 30 s. Immediately following spin coating, films were placed on a 90° C. hot plate for 2 min (FIG. 40). The films were then annealed in a slightly oxidative environment (167-250 ppm O₂) at 525° C. for 1 hour to produce a brown tinted VO₂ film (FIG. 41), which was confirmed with X-ray diffraction (FIG. 42). Planar VO₂ film thickness was determined to be 71 nm.

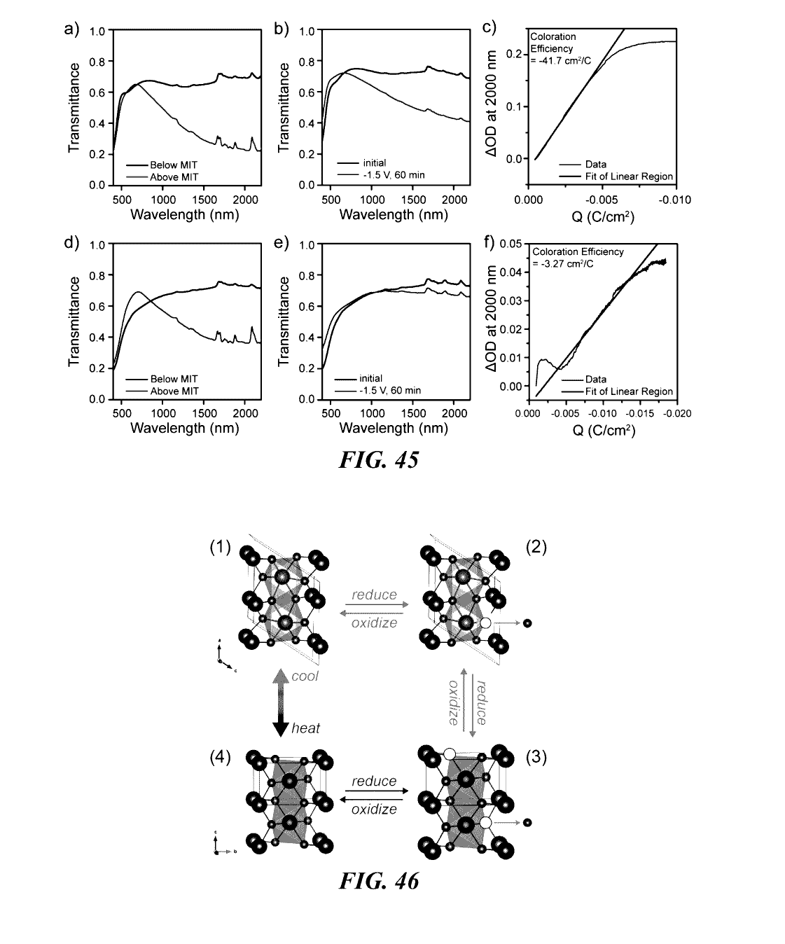

Microcrystalline planar films with significantly larger grains, prepared via the thermal condensation of vanadium oxalate clusters (FIG. 43) (Hordes A et al. J. Mater. Chem. 2011, 21, 11631-11638), showed very little change in IR transmittance upon the application of a reducing bias (FIG. 44 and FIG. 45), and no evidence of bleaching. Thus, nanoscale morphology plays an important role to observing the electrochemical insulator-metal-insulator transition in the device geometry discussed herein. Both surface strain effects and oxygen diffusion kinetics may account for the nanocrystal size-dependence in the biased films. The high electrolyte interfacial area of mesoporous VO₂ nanocrystal films creates more diffusion pathways for oxygen to escape the lattice than in an epitaxial film of equivalent thickness. However, oxygen has been found to diffuse most readily along the ruffle c-axis direction, so a thin epitaxial film with the oxygen-diffusing rutile c-axis channels oriented normal to the substrate, such as the 10 nm epitaxial films prepared by Jeong et al, (Jeong J at al. Proc. Natl. Acad. Sci. 2015, 12, 1013-1018) should have equally favorable oxygen diffusion. Thus, it is likely that strain relaxation also plays an important role in the switching behavior observed herein. A recent study by Passarello et al found that the strain field accompanying oxygen vacancy driven metallicity in electrolyte gated VO₂ decreases exponentially below a thin 6 nm layer at the electrolyte-VO₂ interface (Passarello D et al, Appl. Phys. Lett. 201.5, 107, 201906). Thus, each nanocrystal grain in the biased films discussed herein is expected to be significantly strained, regardless of film thickness. Furthermore, the isotropic distribution of crystal facets in VO₂nanocrystal films may result in spatially inhomogeneous strain fields, rather than the directional strain studied in epitaxial films. A study by Appavoo et al on the size dependence of the thermal metal-to-insulator transition in VO₂nanoparticles made by lithographic patterning found that oxygen vacancy defect formation energy is strongly dependent on interfacial strain and the exposed crystal facet. In fact, they found that oxygen-vacancy formation was most favorable at the (011) facet, rather than the (001) facet exposed in the oriented VO₂ films studied by ionic liquid gating (Appavoo K et al. Nano Lett. 2012, 12, 780-786). Thus, the diversity of exposed facets in the nanocrystal film, and isotropic strain relaxation in nanocrystal grains, can lower oxygen vacancy formation while simultaneously enabling structural phase transformations and rapid oxygen diffusion along favorable lattice directions. These conditions had not been met in prior studies on epitaxial or polycrystalline films, which can explain the observation of an electrochemical insulator-metal-insulator transition for the films discussed herein.

A similar insulator-metal-insulator transition has recently been observed at room temperature upon hydrogenation of epitaxial VO₂ thin films, accompanied by a 10% out-of-plane lattice expansion (Yowl H et al. Nat Mater 2016, 15, 1113-1119). Hydrogen incorporation, like oxygen vacancy formation, is compensated by electrons in the film and decreases vanadium-oxygen orbital mixing in an expanded lattice. Interestingly, the expansion measured in hydrogenated epitaxial VO₂ films is directed along the a lattice parameter, with no concurrent strain in the c lattice parameter as would be observed upon electrolyte gating. Nevertheless, DFT calculations performed by Yoon et al show that the addition of one electron per VO₆ octahedron in the rutile lattice (without any hydrogen) leads to a 16% expansion of the rutile a lattice parameter. This expansion was accompanied by a narrowing of 3d bands, consistent with Yoon's observations of insulating behavior in hydrogenated VO₂. Tungsten doping has also been found to induce a sequential insulator-metal-insulator transition by acting as a substitutional donor dopant in WₓV₁₋ₓO₂. At sufficient doping levels (x>0.09) donor electrons occupy the V3d bands at the Fermi level and induce metallic behavior. However, higher doping (x>0.10) leads to insulating behavior and significant structural expansion. Sakai et al attributed this insulating behavior to either electron correlations or narrowing of V3d bands due to lattice expansion, consistent with Yoon's observations of hydrogenated VO₂ (Shibuya K et al. Appl. Phys. Lett. 2010, 96, 022102; Sakai E et al. Phys. Rev. B 2011, 84, 195132).

Based on the X-ray absorption near-edge spectroscopy results discussed herein (FIG. 37), up to 0.7 electrons may be accumulating per VO₆ octahedron during the bleaching process and this estimate would be expected to induce a significant volume expansion in rutile VO₂ according to Yoon's DFT calculations (Yoon H et al. Nat Mater 2016, 15, 1113-1119). In fact, the 7% volume expansion of the bleached phase estimated from grazing-incidence wide angle X-ray scattering data (Table 2) is roughly consistent with Yoon's results (Yoon H et al. Nat Mater 2016, 15, 1113-1119). However, the different conditions and strain geometry of biased VO₂ nanocrystal films herein and hydrogenated epitaxial VO₂ films in Yoon's work renders a direct comparison of these two phenomena difficult. Therefore, it is proposed that the successive insulator-metal-insulator transformations in biased VO₂ nanocrystals are caused by an increase in oxygen vacancy concentration, which is first compensated by V3d band filling, but at sufficient levels induces band narrowing due to a phase change and isotropic lattice expansion.

In summary, the ability to thermally and electrochemically modulate the IR transmittance of VO₂nanocrystal films, prepared by controlled oxidation of V₂O₃ colloidal nanocrystals, through four distinct transformations was demonstrated (FIG. 46). Initial application of a reducing bias leads to diminished electrical resistance and IR transmittance. However, further reduction of the VO₂ nanocrystal films was found to result in bleaching in the IR and an increase in resistance, leading to a never before seen transition to an expanded, insulating rutile-like state. This progressive optical switching was made possible by the mesoporous nanocrystalline nature of the films, in which the abundant VO₂-electrolyte interfaces facilitate rapid oxygen vacancy formation and diffusion kinetics and strain due to lattice expansion is readily accommodated.

The devices and methods of the appended claims are not limited in scope by the specific devices and methods described herein, which are intended as illustrations of a few aspects of the claims and any devices and methods that are functionally equivalent are within the scope of this disclosure. Various modifications of the devices and methods in addition to those shown and described herein are intended to fall within the scope of the appended claims. Further, while only certain representative devices and methods, and aspects of these devices and methods are specifically described, other devices and methods and combinations of various features of the devices and methods are intended to fall within the scope of the appended claims, even if not specifically recited. Thus a combination of steps, elements, components, or constituents can be explicitly mentioned herein, however, all other combinations of steps, elements, components, and constituents are included, even though not explicitly stated.

What is claimed is:

1. An electrochromic device comprising:
an electrochromic-thermochromic electrode comprising a first conducting layer and an electrochromic-thermochromic layer, wherein the first conducting layer is in electrical contact with the electrochromic-thermochromic layer;
a counter electrode comprising a counter layer and a second conducting layer, wherein the second conducting layer is in electrical contact with the counter layer; and
a non-intercalating electrolyte;
wherein the first conducting layer is in electrical contact with the second conducting layer; and
wherein the electrochromic-thermochromic layer and the counter layer are in electrochemical contact with the non-intercalating electrolyte.

2. The electrochromic device of claim 1, wherein the electrochromic-thermochromic layer comprises VO₂.

3. The electrochromic device of claim 2, wherein the electrochromic-thermochromic material comprises porous nanocrystalline VO₂.

4. The electrochromic device of claim 3, wherein the average pore size in the porous nanocrystalline VO₂ is from 0.5 nm to 100 nm.

5. The electrochromic device of claim 3, wherein the porous nanocrystalline VO₂ comprises a plurality of nanocrystals having an average particle size of from 5 nm to 50 nm.

6. The electrochromic device of claim 1, wherein the electrochromic-thermochromic layer has a thickness of from 30 nm to 300 nm.

7. The electrochromic device of claim wherein the electrochromic-thermochromic layer has a first optical state and a second optical state, wherein each of the first optical state and the second optical state has an average transmittance at one or more wavelengths from 400 to 2200 nm, wherein the average transmittance at the second optical state is less than the average transmittance of the first optical state by 20% or more at one or more wavelengths from 400 nm to 2200 nm, and wherein the electrochromic-thermochromic layer can be switched from the first optical state to the second optical state upon application of a potential to the electrochromic-thermochromic electrode.

8. The electrochromic device of claim 7, wherein the electrochromic-thermochromic layer further has a third optical state, wherein the third optical state has an average transmittance at one or more wavelengths from 400 to 2200 nm, wherein the average transmittance at the second optical state is less than the average transmittance of the third optical state by 20% or more at one or more wavelengths from 400 nm to 2200 nm, and wherein the electrochromic-thermochromic layer can be switched from the second optical state to the third optical state upon application of a potential to the electrochromic-thermochromic electrode.

9. The electrochromic device of claim 1, wherein the non-intercalating electrolyte comprises a compound comprising a cationic moiety and an anionic moiety, wherein the cation moiety has an atomic radius of 2 Å or more.

10. The electrochromic device of claim 9, wherein the cationic moiety comprises an ion selected from the group of R4N⁺, R4P⁺, R₄B⁻, Rb⁺, Cs⁺, Sr²⁺, Ba²⁺, Ca²⁺, K⁺, and combinations thereof, wherein R is any non-hydrogen functional group.

11. The electrochromic device of claim 10, wherein each R is independently a hydrogen or C₁₋₁₂ aliphatic group.

12. The electrochromic device of claim 9, wherein the anionic moiety comprises tetrafluoroborate, tetrakis(pentafluorophenyl borate), hexafluorophospate, perchlorate, bis(trifluoromethyl)sulfonyl)imide, hexafluoroanitmonate, tetrachloroaluminate, trifluoromethylsulfonate, trifluoroacetate, o-tolylsulfonate, or a combination thereof.

13. The electrochromic device claim 1, wherein the first conducting layer and/or the second conducting layer comprise(s) a transparent conducting oxide, a conducting polymer, a carbon material, a nanostructured metal, or a combination thereof.

14. The electrochromic device of claim 1, wherein the first conducting layer and/or the second conducting layer comprises indium tin oxide, fluorine tin oxide, antimony doped tin oxide, indium zinc oxide, polyacetylene, polyalanine, poly(3,4-ethylenedioxythiophene) polystyrene sulfonate, graphene, carbon nanorods, metal nanowires, or combinations thereof.

15. The electrochromic device of claim 1, wherein the counter layer comprises cerium oxide, indium oxide, iridium oxide, nickel oxide, nickel titanium oxide, Prussian blue, zinc oxide, or combinations thereof.

16. The electrochromic device of claim 1, wherein the counter layer comprises a doped metal oxide.

17. The electrochromic device of claim 1, wherein the electrochromic device is a touch panel, an electronic display, a transistor, a smart window, or a combination thereof.

18. A method of making the electrochromic-thermochromic electrode of the electrochromic device of claim 1, the method comprising:
dispersing a plurality of nanocrystals in a solution, thereby forming a mixture;
depositing the mixture on the first conducting layer, thereby forming a precursor layer on the first conducting layer, and
thermally annealing the precursor layer in the presence of oxygen, thereby forming the electrochromic-thermochromic layer.

19. The method of claim 18, wherein thermally annealing the precursor layer comprising heating the precursor layer at a temperature of from 100° C. to 500° C.

20. The method of claim 18, wherein the precursor layer is thermally annealed for from 30 minutes to 90 minutes.

21. The method of claim 18, wherein the oxygen is present at a concentration from 10 ppm to 10,000 ppm.

22. The method of claim 18, wherein the plurality of nanocrystals comprise V₂O₃.

23. The method of claim 18, wherein the plurality of nanocrystals have an average particle size of from 5 nm to 50 nm.

24. The method of claim 18, the method further comprising forming the plurality of nanocrystals.
